(19) United States
(12) Patent Application Publication
(10) Pub. No.: US 2021/0323469 A1
(43) Pub. Date: Oct. 21, 2021

(54) VEHICULAR AROUND VIEW IMAGE PROVIDING APPARATUS AND VEHICLE

(71) Applicant: LG ELECTRONICS INC., Seoul (KR)

(72) Inventors: Jaehoon Lee, Seoul (KR); Taewoong Park, Seoul (KR); Taegil Cho, Seoul (KR)

(21) Appl. No.: 16/490,510

(22) PCT Filed: Jul. 10, 2018
(86) PCT No.: PCT/KR2018/007782

§ 371 Date: Aug. 30, 2019

(51) Int. Cl. B60R 1/00; B60R 11/04; B60W 50/14; B60Q 1/34; G06K 9/00

(52) U.S. Cl. CPC B60R 1/00; B60R 11/04; B60W 50/14; B60Q 1/346; G06K 9/00798; B60W 2050/146; B60R 2300/105; B60R 2300/402; B60R 2300/804; B60R 2300/806; G06K 9/00812

(57) ABSTRACT

Disclosed is a vehicular around view image providing apparatus including a first camera configured to generate a first image, a second camera configured to generate a second image, and a processor configured to generate an around view image by matching a plurality of images including the first image and the second image, to compare a first feature of a first object detected based on the first image with a second feature of the first object detected based on the second image, and to perform calibration on at least one of the first image, the second image, or the around view image.

### TECHNICAL FIELD

The present invention relates to a vehicular around view image providing apparatus and a vehicle

### BACKGROUND ART

A vehicle refers to a device that carries a passenger in a passenger-intended direction. A car is a major example of the vehicle.

To increase the convenience of vehicle users, a vehicle is equipped with various sensors and electronic devices. Especially, an advanced driver assistance system (ADAS) and an autonomous vehicle are under active study to increase the driving convenience of users.

An around view monitoring apparatus (AVM) is provided as one of ADASs. The AVM matches a plurality of images generated from a plurality of cameras to provide an around view image.

A vehicle stance with respect to a road surface and a camera pose with respect to a vehicle are gradually changed over a long time span due to an effect of a road or a structure thereon, such as contact with a road surface or impact from a speed bump, change in a tire state, and deterioration of a vehicle. Then, there is a problem in that an around view image is distorted or the continuity of an object breaks. In this case, capability of automatically correcting an around view image on-road has become more important in order to output a more appropriate image.

However, from a user point of view, it is very inconvenient to guide calibration for a user in the same manner as a method at the release of a vehicle, which uses a pattern for recognizing a corresponding relation such as a checker board, in order to correct a camera pose on-road.

### DISCLOSURE

### Technical Problem

It is an object of the present invention to provide a vehicular around view image providing apparatus for user-friendly performing calibration even on-road.

It is another object of the present invention to provide a vehicle including a vehicular around view image providing apparatus.

The technical problems solved by the embodiments are not limited to the above technical problems and other technical problems which are not described herein will become apparent to those skilled in the art from the following description.

### Technical Solution

In accordance with the present invention, the above and other objects can be accomplished by the provision of a vehicular around view image providing apparatus for comparing a first feature of a first object detected from a first camera with a second feature of the first object detected from a second image of a second camera and performing calibration.

Details of other embodiments are included in a detailed description and drawings.

### Advantageous Effects

According to the above technical solution, the present invention may provide one or more of the following effects.

First, calibration may be performed without user inconvenience by performing calibration based on an object detected from an image on-road of a vehicle.

Second, a signal for vehicle movement may be provided, and thus an image required for performing calibration may be acquired.

Third, a signal for outputting guidance of a user position may be provided, and thus calibration may be performed even in a situation in which there is no object around the vehicle.

The effects of the present invention are not limited to the above-described effects and other effects which are not described herein may be derived by those skilled in the art from the following description of the embodiments of the disclosure.

### DESCRIPTION OF DRAWINGS

FIG. 1 shows the exterior of a vehicle according to an embodiment of the present invention.

FIG. 2 is a view illustrating exteriors of a vehicle, seen at various angles from the outside of the vehicle according to an embodiment of the present invention.

FIGS. 3 and 4 are views illustrating the interior of a vehicle according to an embodiment of the present invention.

FIGS. 5 and 6 are views referred to for describing objects according to an embodiment of the present invention.

FIG. 7 is a block diagram of a vehicle according to an embodiment of the present invention.

Referring to FIG. 8A, a vehicular around view image providing device 800 includes a plurality of cameras 810.

FIG. 8B illustrates an around view image generated by a vehicular around view image providing apparatus according to an embodiment of the present invention.

FIG. 9 is a block diagram for explanation of a vehicular around view image providing apparatus according to an embodiment of the present invention.

FIG. 10 is a diagram for explanation of an operation of a vehicular around view image providing apparatus according to an embodiment of the present invention.

FIG. 11 is a diagram for explanation of a vehicular around view image providing apparatus according to an embodiment of the present invention.

FIGS. 12 and 13 are diagrams showing an example of a plurality of images generated from a plurality of images according to an embodiment of the present invention.

FIGS. 14 to 23 are diagrams for explanation of various operation scenarios of a vehicular around view image providing apparatus according to an embodiment of the present invention.

### BEST MODE

Reference will now be made in detail to the preferred embodiments of the present invention, examples of which are illustrated in the accompanying drawings. Wherever possible, the same reference numbers will be used throughout the drawings to refer to the same or like parts. As used herein, the suffixes “module” and “unit” are added or interchangeably used to facilitate preparation of this specification and are not intended to suggest unique meanings or functions. In describing embodiments disclosed in this specification, a detailed description of relevant well-known technologies may not be given in order not to obscure the subject matter of the present invention. In addition, the accompanying drawings are merely intended to facilitate understanding of the embodiments disclosed in this specification and not to restrict the technical spirit of the present invention. In addition, the accompanying drawings should be understood as covering all equivalents or substitutions within the scope of the present invention.

Terms including ordinal numbers such as first, second, etc. may be used to explain various elements. However, it will be appreciated that the elements are not limited to such terms. These terms are merely used to distinguish one element from another.

Stating that one constituent is “connected” or “linked” to another should be understood as meaning that the one constituent may be directly connected or linked to another constituent or another constituent may be interposed between the constituents. On the other hand, stating that one constituent is “directly connected” or “directly linked” to another should be understood as meaning that no other constituent is interposed between the constituents.

As used herein, the singular forms “a”, “an”, and “the” are intended to include the plural forms as well, unless context clearly indicates otherwise.

In this specification, terms such as “includes” or “has” are intended to indicate existence of characteristics, figures, steps, operations, constituents, components, or combinations thereof disclosed in the specification. The terms “includes” or “has” should be understood as not precluding possibility of existence or addition of one or more other characteristics, figures, steps, operations, constituents, components, or combinations thereof.

The term “vehicle” employed in this specification may include an automobile and a motorcycle. Hereinafter, description will be given mainly focusing on an automobile.

The vehicle described in this specification may include a vehicle equipped with an internal combustion engine as a power source, a hybrid vehicle equipped with both an engine and an electric motor as a power source, and an electric vehicle equipped with an electric motor as a power source.

In the description below, the left side of the vehicle means the left side with respect to the travel direction of the vehicle and the right side of the vehicle means the right side with respect to the travel direction of the vehicle.

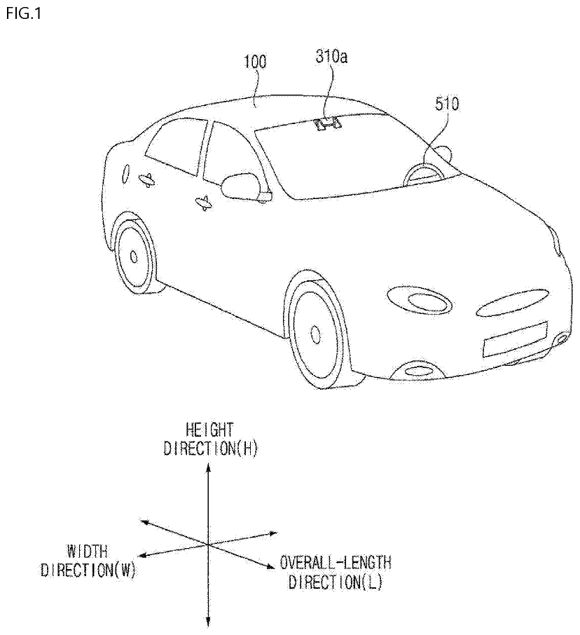

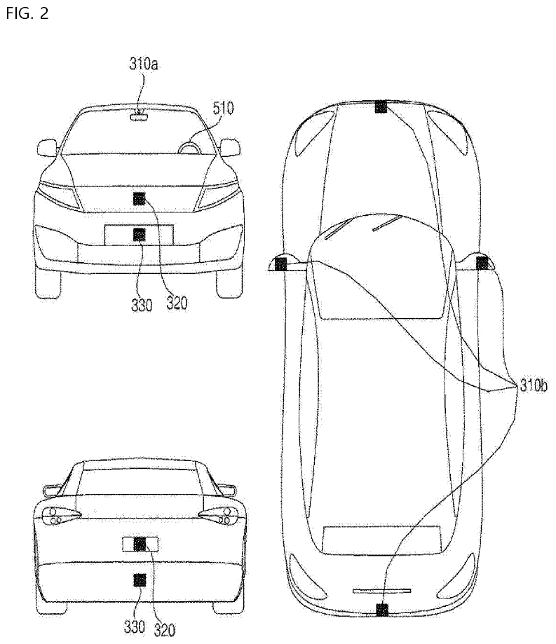

FIG. 1 shows the exterior of a vehicle according to an embodiment of the present invention.

FIG. 2 is a view illustrating exteriors of a vehicle, seen at various angles from the outside of the vehicle according to an embodiment of the present invention.

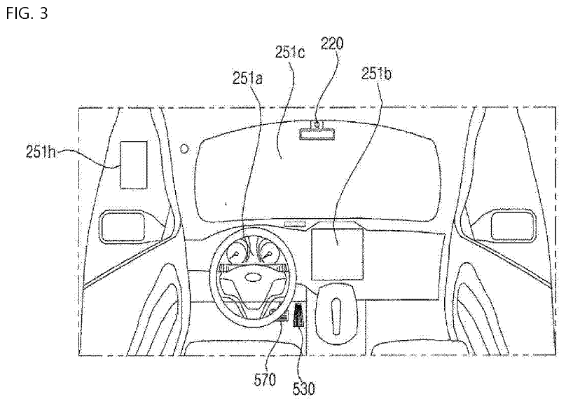

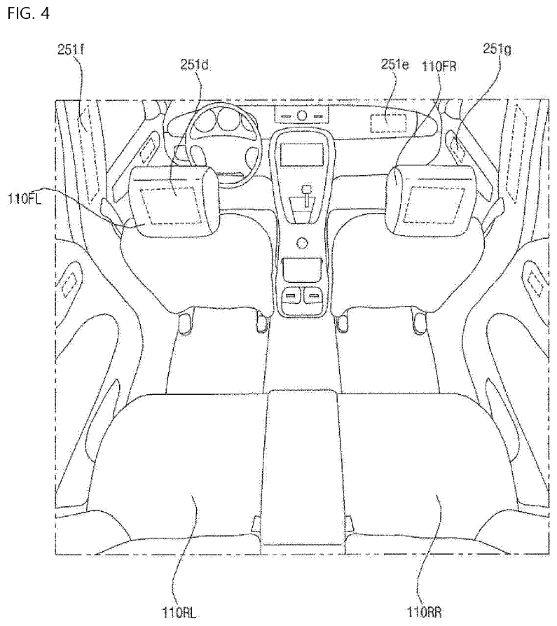

FIGS. 3 and 4 are views illustrating the interior of a vehicle according to an embodiment of the present invention.

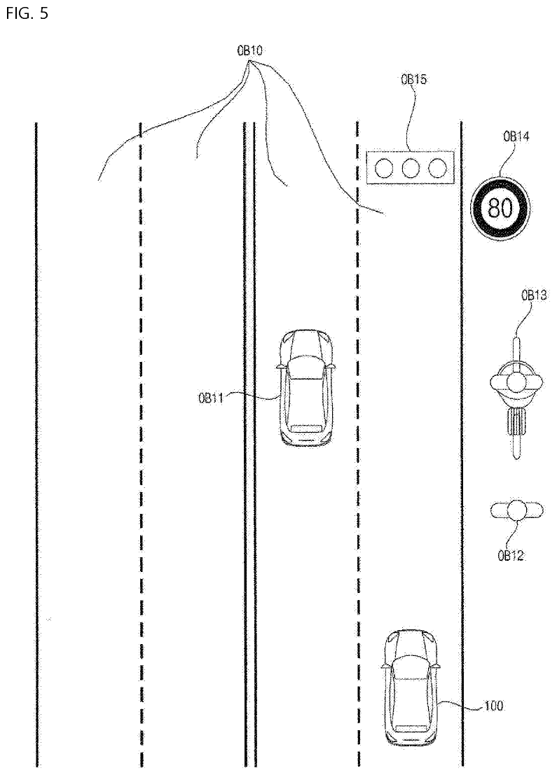

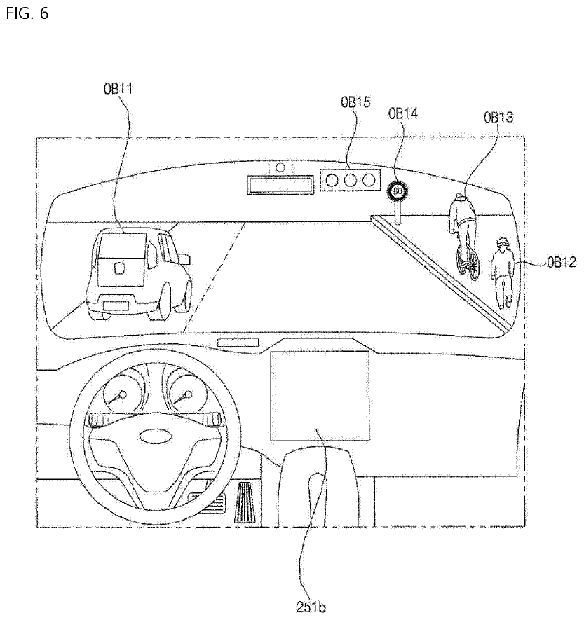

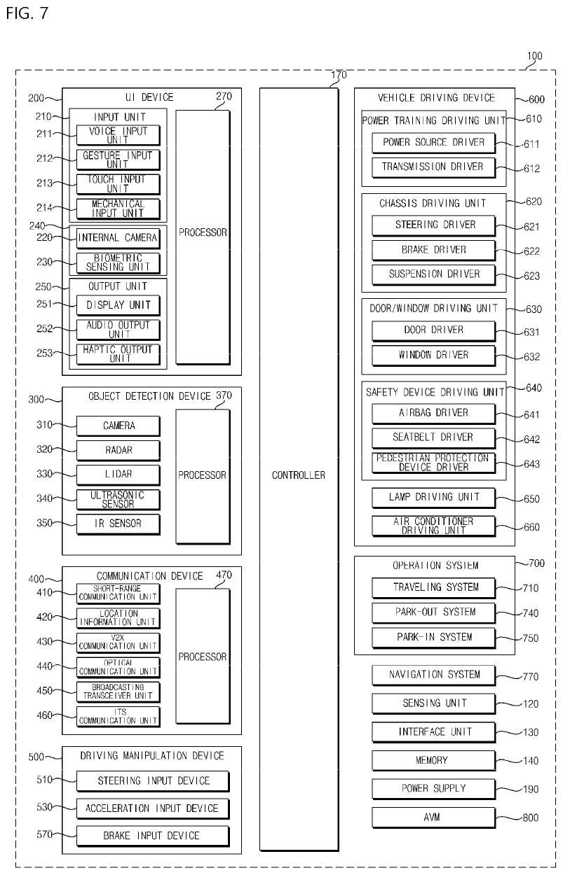

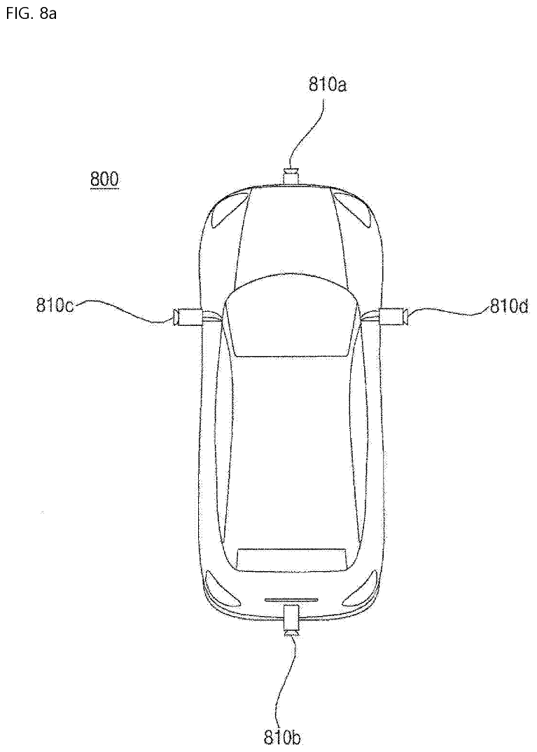

FIGS. 5 and 6 are views referred to for describing objects according to an embodiment of the present invention. FIG. 7 is a block diagram of a vehicle according to an embodiment of the present invention.

Referring to FIGS. 1 to 7, a vehicle 100 may include wheels rotated by a power source, and a steering input device 510 for controlling a travel direction of the vehicle 100.

The vehicle 100 may be an autonomous vehicle.

The vehicle 100 may switch to an autonomous driving mode or a manual mode according to a user input.

For example, the vehicle 100 may switch from the manual mode to the autonomous driving mode or from the autonomous driving mode to the manual mode, based on a user input received through a User Interface (UI) device 200.

The vehicle 100 may switch to the autonomous driving mode or the manual mode based on traveling situation information.

The traveling situation information may include at least one of information about objects outside the vehicle, navigation information, or vehicle state information.

For example, the vehicle 100 may switch from the manual mode to the autonomous driving mode or from the autonomous driving mode to the manual mode, based on traveling situation information generated from an object detection device 300.

For example, the vehicle 100 may switch from the manual mode to the autonomous driving mode or from the autonomous driving mode to the manual mode, based on traveling situation information generated from a communication device 400.

The vehicle 100 may switch from the manual mode to the autonomous driving mode or from the autonomous driving mode to the manual mode, based on information, data, or a signal provided from an external device.

If the vehicle 100 travels in the autonomous driving mode, the autonomous vehicle 100 may be operated based on an operation system 700.

For example, the autonomous vehicle 100 may travel based on information, data, or signals generated from a traveling system 710, a park-out system 740, and a park-in system.

If the vehicle 100 drives in the manual mode, the autonomous vehicle 100 may receive a user input for driving through a driving manipulation device 500. The vehicle 100 may travel based on the user input received through the driving manipulation device 500.

The overall length refers to the length of the vehicle 100 from the front to back of the vehicle 100, the width refers to the width of the vehicle 100, and the height refers to the distance from the bottom of wheels to the roof of the vehicle. In the description below, the overall-length direction L may indicate a direction in which measurement of overall length of the vehicle 100 is performed, the width direction W may indicate a direction in which measurement of width of the vehicle 100 is performed, and the height direction H may indicate a direction in which measurement of height of the vehicle 100 is performed.

As illustrated in FIG. 7, the vehicle 100 may include the UI device 200, the object detection device 300, the communication device 400, the driving manipulation device 500, a vehicle driving device 600, the operation system 700, a navigation system 770, a sensing unit 120, an interface unit 130, a memory 140, a controller 170, a power supply 190, and a vehicular around view image providing device 800.

In some embodiments, the vehicle 100 may further include a new component in addition to the components described in the present invention, or may not include a part of the described components.

The UI device 200 is used to enable the vehicle 100 to communicate with a user. The UI device 200 may receive a user input, and provide information generated from the vehicle 100 to the user. The vehicle 100 may implement UIs or User Experience (UX) through the UI device 200.

The UI device 200 may include an input unit 210, an internal camera 220, a biometric sensing unit 230, an output unit 250, and a processor 270.

In some embodiments, the UI device 200 may further include a new component in addition to components described below, or may not include a part of the described components.

The input unit 210 is provided to receive information from a user. Data collected by the input unit 210 may be analyzed by the processor 270 and processed as a control command from the user.

The input unit 210 may be disposed inside the vehicle 100. For example, the input unit 210 may be disposed in an area of a steering wheel, an area of an instrument panel, an area of a seat, an area of a pillar, an area of a door, an area of a center console, an area of a head lining, an area of a sun visor, an area of a windshield, an area of a window, or the like.

The input unit 210 may include a voice input unit 211, a gesture input unit 212, a touch input unit 213, and a mechanical input unit 214.

The voice input unit 211 may convert a voice input of the user to an electrical signal. The electrical signal may be provided to the processor 270 or the controller 170.

The voice input unit 211 may include one or more microphones.

The gesture input unit 212 may convert a gesture input of the user to an electrical signal. The electrical signal may be provided to the processor 270 or the controller 170.

The gesture input unit 212 may include at least one of an infrared (IR) sensor or an image sensor, for sensing a gesture input of the user.

In some embodiments, the gesture input unit 212 may sense a three-dimensional (3D) gesture input of the user. For this purpose, the gesture input unit 212 may include a light output unit for emitting a plurality of IR rays or a plurality of image sensors.

The gesture input unit 212 may sense a 3D gesture input of the user by Time of Flight (ToF), structured light, or disparity.

The touch input unit 213 may convert a touch input of the user to an electrical signal. The electrical signal may be provided to the processor 270 or the controller 170.

The touch input unit 213 may include a touch sensor for sensing a touch input of the user.

In some embodiments, a touch screen may be configured by integrating the touch input unit 213 with a display unit 251. The touch screen may provide both an input interface and an output interface between the vehicle 100 and the user.

The mechanical input unit 214 may include at least one of a button, a dome switch, a jog wheel, or a jog switch. An electrical signal generated by the mechanical input unit 214 may be provided to the processor 270 or the controller 170.

The mechanical input unit 214 may be disposed on the steering wheel, the center fascia, the center console, the cockpit module, a door, or the like.

The internal camera 220 may acquire a vehicle interior image. The processor 270 may sense a state of a user based on the vehicle interior image. The processor 270 may acquire information about the gaze of a user in the vehicle interior image. The processor 270 may sense the user's gesture in the vehicle interior image.

The biometric sensing unit 230 may acquire biometric information about a user. The biometric sensing unit 230 may include a sensor for acquiring biometric information about a user, and acquire information about a fingerprint, heart beats, and so on of a user, using the sensor. The biometric information may be used for user authentication.

The output unit 250 is provided to generate a visual output, an acoustic output, or a haptic output.

The output unit 250 may include at least one of the display unit 251, an audio output unit 252, or a haptic output unit 253.

The display unit 251 may display graphic objects corresponding to various kinds of information.

The display unit 251 may include at least one of a liquid crystal display (LCD), a thin film transistor-liquid crystal display (TFT LCD), an organic light-emitting diode (OLED) display, a flexible display, a 3D display, or an e-ink display.

The display unit 251 may form a layered structure together with the touch input unit 213 or be integrated with the touch input unit 213, thereby implementing a touchscreen.

The display unit 251 may be implemented as a head up display (HUD). In this case, the display unit 251 may be provided with a projection module, and output information by an image projected onto the windshield or a window.

The display unit 251 may include a transparent display. The transparent display may be attached to the windshield or a window.

The transparent display may display a specific screen with a specific transparency. To have a transparency, the transparent display may include at least one of a transparent Thin Film Electroluminescent (TFFL) display, a transparent OLED display, a transparent LCD, a transmissive transparent display, or a transparent LED display. The transparency of the transparent display is adjustable.

The UI device 200 may include a plurality of display units 251a to 251g.

The display unit 251 may be disposed in an area of the steering wheel, areas 251a, 251b, and 251e of the instrument panel, an area 251d of a seat, an area 251f of a pillar, an area 251g of a door, an area of the center console, an area of a head lining, or an area of a sun visor, or may be implemented in an area 251c of the windshield, and an area 251h of a window.

The audio output unit 252 converts an electrical signal received from the processor 270 or the controller 170 to an audio signal, and outputs the audio signal. To this end, the audio output unit 252 may include one or more speakers.

The haptic output unit 253 generates a haptic output. For example, the haptic output unit 253 may vibrate the steering wheel, a seat belt, a seat 110FL, 110FR, 110RL, or 110RR, so that a user may perceive the output.

The processor 270 may control an operation of each unit of the UI device 200.

In some embodiments, the UI device 200 may include a plurality of processors 270 or no processor 270.

If the UI device 200 does not include any processor 270, the UI device 200 may operate under control of a processor of another device in the vehicle 100, or under control of the controller 170.

The UI device 200 may be referred to as a vehicle display device.

The UI device 200 may operate under control of the controller 170.

The object detection device 300 is used to detect an object outside the vehicle 100. The object detection device 300 may generate object information based on sensing data.

The object information may include information indicating presence or absence of an object, information about the location of an object, information indicating the distance between the vehicle 100 and the object, and information about a relative speed of the vehicle 100 with respect to the object.

The object may be any of various objects related to driving of the vehicle 100.

Referring to FIGS. 5 and 6, the object O may include a lane OB10, another vehicle OB11, a pedestrian OB12, a two-wheeled vehicle OB13, a traffic signal OB14 and OB15, light, a road, a structure, a speed bump, a geographical feature, and an animal.

The lane OB10 may include a traveling lane, a lane next to the traveling lane, and a lane in which a vehicle is driving in the opposite direction. The lane OB10 may conceptually include left and right lines that define each of the lanes. The lane may conceptually include an intersection.

The other vehicle OB11 may be a vehicle traveling in the vicinity of the vehicle 100. The other vehicle OB11 may be located within a predetermined distance from the vehicle 100. For example, the other vehicle OB11 may precede or follow the vehicle 100.

The pedestrian OB12 may be a person located around the vehicle 100. The pedestrian OB12 may be a person located within a predetermined distance from the vehicle 100. For example, the pedestrian OB12 may be a person on a sidewalk or a roadway.

The two-wheel vehicle OB13 may refer to a transportation means moving on two wheels, located around the vehicle 100. The two-wheel vehicle OB13 may be a transportation means having two wheels, located within a predetermined distance from the vehicle 100. For example, the 2-wheel vehicle OB13 may be a motorcycle or bicycle on a sidewalk or a roadway.

The traffic signals may include a traffic signal lamp OB15, a traffic sign OB14, and a symbol or text drawn or written on a road surface.

The light may be light generated from a lamp of another vehicle. The light may be generated from a street lamp. The light may be sunlight.

The road may include a road surface, a curve, and a slope such as an uphill or downhill road.

The structure may be an object fixed on the ground, near to a road. For example, the structure may be any of a street lamp, a street tree, a building, a utility pole, a signal lamp, a bridge, a curb, and a wall.

The geographical feature may include a mountain, a hill, and so on.

Objects may be classified into mobile objects and stationary objects. For example, the mobile objects may conceptually include another moving vehicle and a moving pedestrian. For example, the stationary objects may conceptually include a traffic signal, a road, a structure, another stationary vehicle, and a stationary pedestrian.

The object detection device 300 may include a camera 310, a Radio Detection and Ranging (RADAR) 320, a Light Detection and Ranging (LiDAR) 330, an ultrasonic sensor 340, an IR sensor 350, and a processor 370.

In some embodiments, the object detection device 300 may further include a new component in addition to components described below or may not include a part of the described components.

To acquire a vehicle exterior image, the camera 310 may be disposed at an appropriate position on the exterior of the vehicle 100. The camera 310 may be a mono camera, a stereo camera 310a, around view monitoring (AVM) cameras 310b, or a 360-degree camera.

The camera 310 may acquire information about the location of an object, information about a distance to the object, or information about a relative speed with respect to the object by any of various image processing algorithms.

For example, the camera 310 may acquire information about a distance to an object and information about a relative speed with respect to the object in an acquired image, based on a variation in the size of the object over time.

For example, the camera 310 may acquire information about a distance to an object and information about a relative speed with respect to the object through a pin hole model, road surface profiling, or the like.

For example, the camera 310 may acquire information about a distance to an object and information about a relative speed with respect to the object based on disparity information in a stereo image acquired by the stereo camera 310a.

For example, to acquire an image of the front view of the vehicle 100, the camera 310 may be disposed in the vicinity of a front windshield inside the vehicle 100. Alternatively, the camera 310 may be disposed around a front bumper or a radiator grille.

For example, to acquire an image of what lies behind the vehicle 100, the camera 310 may be disposed in the vicinity of a rear glass inside the vehicle 100. Or the camera 310 may be disposed around a rear bumper, a trunk, or a tail gate.

For example, to acquire an image of what lies on a side of the vehicle 100, the camera 310 may be disposed in the vicinity of at least one of side windows inside the vehicle 100. Alternatively, the camera 310 may be disposed around a side view mirror, a fender, or a door.

The camera 310 may provide an acquired image to the processor 370.

The RADAR 320 may include an electromagnetic wave transmitter and an electromagnetic wave receiver. The RADAR 320 may be implemented by pulse RADAR or continuous wave RADAR. The RADAR 320 may be implemented by Frequency Modulated Continuous Wave (FMCW) or Frequency Shift Keying (FSK) as a pulse RADAR scheme according to a signal waveform.

The RADAR 320 may detect an object in TOF or phase shifting by electromagnetic waves, and determine the location, distance, and relative speed of the detected object.

The RADAR 320 may be disposed at an appropriate position on the exterior of the vehicle 100 in order to sense an object ahead of, behind, or on a side of the vehicle 100.

The LiDAR 330 may include a laser transmitter and a laser receiver. The LiDAR 330 may be implemented in TOF or phase shifting.

The LiDAR 330 may be implemented in a driven or non-driven manner.

If the LiDAR 330 is implemented in the driven manner, the LiDAR 330 may be rotated by a motor and detect an object around the vehicle 100.

If the LiDAR 330 is implemented in a non-driven manner, the LiDAR 330 may detect an object within a predetermined range from the vehicle 100 by optical steering. The vehicle 100 may include a plurality of non-driven LiDARs 330.

The LiDAR 330 may detect an object in TOF or phase shifting by laser light, and determine the location, distance, and relative speed of the detected object.

The LiDAR 330 may be disposed at an appropriate position on the exterior of the vehicle 100 in order to sense an object ahead of, behind, or on a side of the vehicle 100.

The ultrasonic sensor 340 may include an ultrasonic wave transmitter and an ultrasonic wave receiver. The ultrasonic sensor 340 may detect an object by ultrasonic waves, and determine the location, distance, and relative speed of the detected object.

The ultrasonic sensor 340 may be disposed at an appropriate position on the exterior of the vehicle 100 in order to sense an object ahead of, behind, or on a side of the vehicle 100.

The IR sensor 350 may include an IR transmitter and an IR receiver. The IR sensor 350 may detect an object by IR light, and determine the location, distance, and relative speed of the detected object.

The IR sensor 350 may be disposed at an appropriate position on the exterior of the vehicle 100 in order to sense an object ahead of, behind, or on a side of the vehicle 100.

The processor 370 may control an overall operation of each unit of the object detection device 300.

The processor 370 may compare data sensed by a camera 310, a RADAR 320, a LiDAR 330, an ultrasonic sensor 340, and an IR sensor 350 with pre-stored data to detect or classify an object.

The processor 370 may detect and track an object based on the acquired image. The processor 370 may calculate a distance to the object, a relative speed with respect to the object, and so on by an image processing algorithm.

For example, the processor 370 may acquire information about a distance to an object and information about a relative speed with respect to the object from an acquired image, based on a variation in the size of the object over time.

For example, the processor 370 may acquire information about a distance to an object and information about a relative speed with respect to the object from an image acquired from the stereo camera 310a.

For example, the processor 370 may acquire information about a distance to an object and information about a relative speed with respect to the object from an image acquired from the stereo camera 310a, based on disparity information.

The processor 370 may detect an object and track the detected object based on electromagnetic waves which are transmitted, are reflected from an object, and then return. The processor 370 may calculate a distance to the object and a relative speed with respect to the object, based on the electromagnetic waves.

The processor 370 may detect an object and track the detected object based on laser light which is transmitted, is reflected from an object, and then returns. The sensing processor 370 may calculate a distance to the object and a relative speed with respect to the object, based on the laser light.

The processor 370 may detect an object and track the detected object based on ultrasonic waves which are transmitted, are reflected from an object, and then return. The processor 370 may calculate a distance to the object and a relative speed with respect to the object, based on the ultrasonic waves.

The processor 370 may detect an object and track the detected object based on IR light which is transmitted, is reflected from an object, and then returns. The processor 370 may calculate a distance to the object and a relative speed with respect to the object, based on the IR light.

In some embodiments, the object detection device 300 may include a plurality of processors 370 or no processor 370. For example, the camera 310, the RADAR 320, the LiDAR 330, the ultrasonic sensor 340, and the IR sensor 350 may include individual processors.

If the object detection device 300 includes no processor 370, the object detection device 300 may operate under control of a processor of a device in the vehicle 100 or under control of the controller 170.

The object detection device 300 may operate under control of the controller 170.

The communication device 400 is used to communicate with an external device. The external device may be another vehicle, a mobile terminal, or a server.

The communication device 400 may include at least one of a transmit antenna and a receive antenna, for communication, or a Radio Frequency (RF) circuit and device, for implementing various communication protocols.

The communication device 400 may include a short-range communication unit 410, a location information unit 420, a vehicle-to-everything (V2X) communication unit 430, an optical communication unit 440, a broadcasting transceiver unit 450, an intelligent transport system (ITS) communication unit 460, and a processor 470.

In some embodiments, the communication device 400 may further include a new component in addition to components described below, or may not include a part of the described components.

The short-range communication module 410 is a unit for conducting short-range communication. The short-range communication module 410 may support short-range communication, using at least one of Bluetooth™, Radio Frequency Identification (RFID), Infrared Data Association (IrDA), Ultra Wideband (UWB), ZigBee, Near Field Communication (NFC), Wireless Fidelity (Wi-Fi), Wi-Fi Direct, or Wireless Universal Serial Bus (Wireless USB).

The short-range communication unit 410 may conduct short-range communication between the vehicle 100 and at least one external device by establishing a wireless area network.

The location information unit 420 is a unit configured to acquire information about a location of the vehicle 100. The location information unit 420 may include at least one of a global positioning system (GPS) module or a Differential Global Positioning System (DGPS) module.

The V2X communication unit 430 is a unit used for wireless communication with a server (by vehicle-to-infrastructure (V2I)), another vehicle (by Vehicle to Vehicle (V2V)), or a pedestrian (by Vehicle to Pedestrian (V2P)). The V2X communication unit 430 may include an RF circuit capable of implementing a V2I protocol, a V2V protocol, and a V2P protocol.

The optical communication unit 440 is a unit used to communicate with an external device by light. The optical communication unit 440 may include an optical transmitter for converting an electrical signal to an optical signal and emitting the optical signal to the outside, and an optical receiver for converting a received optical signal to an electrical signal.

In some embodiments, the optical transmitter may be integrated with a lamp included in the vehicle 100.

The broadcasting transceiver unit 450 is a unit used to receive a broadcast signal from an external broadcasting management server or transmit a broadcast signal to the broadcasting management server, on a broadcast channel. The broadcast channel may include a satellite channel and a terrestrial channel. The broadcast signal may include a TV broadcast signal, a radio broadcast signal, and a data broadcast signal.

The ITS communication unit 460 may exchange information, data, or signals with a traffic system. The ITS communication unit 460 may provide acquired information and data to the traffic system. The ITS communication unit 460 may receive information, data, or a signal from the traffic system. For example, the ITS communication unit 460 may receive traffic information from the traffic system and provide the received traffic information to the controller 170. For example, the ITS communication unit 460 may receive a control signal from the traffic system, and provide the received control signal to the controller 170 or a processor in the vehicle 100.

The processor 470 may control an overall operation of each unit of the communication device 400.

In some embodiments, the communication device 400 may include a plurality of processors 470 or no processor 470.

If the communication device 400 does not include any processor 470, the communication device 400 may operate under control of a processor of another device in the vehicle 100 or under control of the controller 170.

The communication device 400 may be configured along with the UI device 200, as a vehicle multimedia device. In this case, the vehicle multimedia device may be referred to as a telematics device or an Audio Video Navigation (AVN) device.

The communication device 400 may operate under control of the controller 170.

The driving manipulation device 500 is used to receive a user command for driving the vehicle 100.

In the manual mode, the vehicle 100 may travel based on a signal provided by the driving manipulation device 500.

The driving manipulation device 500 may include the steering input device 510, an acceleration input device 530, and a brake input device 570.

The steering input device 510 may receive a travel direction input for the vehicle 100 from a user. The steering input device 510 may take the form of a wheel to rotate to provide a steering input. In some embodiments, the steering input device 510 may be configured as a touch screen, a touchpad, or a button.

The acceleration input device 530 may receive an input for acceleration of the vehicle 100 from the user. The brake input device 570 may receive an input for deceleration of the vehicle 100 from the user. The acceleration input device 530 and the brake input device 570 are preferably formed into pedals. In some embodiments, the acceleration input device 530 or the brake input device 570 may be configured as a touch screen, a touchpad, or a button.

The driving manipulation device 500 may operate under control of the controller 170.

The vehicle driving device 600 is used to electrically control operations of various devices of the vehicle 100.

The vehicle driving device 600 may include at least one of a power train driving unit 610, a chassis driving unit 620, a door/window driving unit 630, a safety device driving unit 640, a lamp driving unit 650, or an air conditioner driving unit 660.

In some embodiments, the vehicle driving device 600 may further include a new component in addition to components described below or may not include a part of the components.

The vehicle driving device 600 may include a processor. Each unit of the vehicle driving device 600 may include a processor.

The power train driving unit 610 may control operation of a power train device.

The power train driving unit 610 may include a power source driver 611 and a transmission driver 612.

The power source driver 611 may control a power source of the vehicle 100.

For example, if the power source is a fossil fuel-based engine, the power source driver 611 may perform electronic control on the engine. Therefore, the power source driver 611 may control an output torque of the engine, and the like. The power source driver 611 may adjust the engine output torque under control of the controller 170.

For example, if the power source is an electrical energy-based motor, the power source driver 610 may control the motor. The power source driver 610 may adjust a rotation speed, torque, and so on of the motor under control of the controller 170.

The transmission driver 612 may control a transmission.

The transmission driver 612 may adjust a state of the transmission. The transmission driver 612 may adjust the state of the transmission to drive D, reverse R, neutral N, or park P.

If the power source is the engine, the transmission driver 612 may adjust the engagement state of gears in the drive mode D.

The chassis driving unit 620 may control operation of a chassis device.

The chassis driving unit 620 may include a steering driver 621, a brake driver 622, and a suspension driver 623.

The steering driver 621 may perform electronic control on a steering device in the vehicle 100. The steering driver 621 may change a travel direction of the vehicle 100.

The brake driver 622 may perform electronic control on a brake device in the vehicle 100. For example, the brake driver 622 may decrease the speed of the vehicle 100 by controlling an operation of a brake disposed at a wheel.

The brake driver 622 may control a plurality of brakes individually. The brake driver 622 may control braking power applied to a plurality of wheels differently.

The suspension driver 623 may perform electronic control on a suspension device in the vehicle 100. For example, if the surface of a road is rugged, the suspension driver 623 may control the suspension device to reduce jerk of the vehicle 100.

The suspension driver 623 may control a plurality of suspensions individually.

The door/window driving unit 630 may perform electronic control on a door device or a window device in the vehicle 100.

The door/window driving unit 630 may include a door driver 631 and a window driver 632.

The door driver 631 may perform electronic control on a door device in the vehicle 100. For example, the door driver 631 may control opening and closing of a plurality of doors in the vehicle 100. The door driver 631 may control opening or closing of the trunk or the tail gate. The door driver 631 may control opening or closing of the sunroof.

The window driver 632 may perform electronic control on a window device in the vehicle 100. The window driver 632 may control opening or closing of a plurality of windows in the vehicle 100.

The safety device driving unit 640 may perform electronic control on various safety devices in the vehicle 100.

The safety device driving unit 640 may include an airbag driver 641, a seatbelt driver 642, and a pedestrian protection device driver 643.

The airbag driver 641 may perform electronic control on an airbag device in the vehicle 100. For example, the airbag driver 641 may control inflation of an airbag, upon sensing an emergency situation.

The seatbelt driver 642 may perform electronic control on a seatbelt device in the vehicle 100. For example, the seatbelt driver 642 may control securing of passengers on the seats 110FL, 110FR, 110RL, and 110RR by means of seatbelts, upon sensing a danger.

The pedestrian protection device driver 643 may perform electronic control on a hood lift and a pedestrian airbag. For example, the pedestrian protection device driver 643 may control the hood to be lifted up and the pedestrian airbag to be inflated, upon sensing collision with a pedestrian.

The lamp driving unit 650 may perform electronic control on various lamp devices in the vehicle 100.

The air conditioner driving unit 660 may perform electronic control on an air conditioner in the vehicle 100. For example, if a vehicle internal temperature is high, the air conditioner driver 660 may control the air conditioner to operate and supply cool air into the vehicle 100.

The vehicle driving device 600 may include a processor. Each unit of the vehicle driving device 600 may include a processor.

The vehicle driving device 600 may operate under control of the controller 170.

The operation system 700 is a system that controls various operations of the vehicle 100. The operation system 700 may operate in the autonomous driving mode.

The operation system 700 may include the traveling system 710, the park-out system 740, and the park-in system 750.

In some embodiments, the operation system 700 may further include a new component in addition to components described below or may not include a part of the described components.

The operation system 700 may include a processor. Each unit of the operation system 700 may include a processor.

In some embodiments, if the operation system 700 is implemented in software, the operation system 700 may lie under controller 170 in concept.

In some embodiments, the operation system 700 may conceptually include at least one of the UI device 270, the object detection device 300, the communication device 400, the vehicle driving device 600, the controller 170, the navigation system 770, the sensing unit 120, or the controller 170.

The traveling system 710 may drive the vehicle 100.

The traveling system 710 may drive the vehicle 100 by providing a control signal to the vehicle driving device 600 based on navigation information received from the navigation system 770.

The traveling system 710 may drive the vehicle 100 by providing a control signal to the vehicle driving device 600 based on object information received from the object detection device 300.

The traveling system 710 may drive the vehicle 100 by receiving a signal from an external device through the communication device 400 and providing a control signal to the vehicle driving device 600.

The traveling system 710 may include the UI device 270, the object detection device 300, the communication device 400, the driving manipulation device 500, the vehicle driving device 600, the navigation system 770, the sensing unit 120, or the controller 170 and may conceptually be a system that drives the vehicle 100.

The traveling system 710 may be referred to as a vehicle traveling control device.

The park-out system 740 may perform park-out of the vehicle 100.

The park-out system 740 may perform park-out of the vehicle 100 by providing a control signal to the vehicle driving device 600 according to navigation information received from the navigation system 770.

The park-out system 740 may perform park-out of the vehicle 100 by providing a control signal to the vehicle driving device 600 based on object information received from the object detection device 300.

The park-out system 740 may perform park-out of the vehicle 100 by receiving a signal from an external device through the communication device 400 and providing a control signal to the vehicle driving device 600.

The park-out system 740 may include at least one of the UI device 270, the object detection device 300, the communication device 400, the driving manipulation device 500, the vehicle driving device 600, the navigation system 770, the sensing unit 120, or the controller 170 and may conceptually be a system that performs park-out of the vehicle 100.

The park-out system 740 may be referred to as a vehicle park-out control device.

The park-in system 750 may perform park-in of the vehicle 100.

The park-in system 750 may perform park-in of the vehicle 100 by providing a control signal to the vehicle driving device 600 according to navigation information received from the navigation system 770.

The park-in system 750 may perform park-in of the vehicle 100 by providing a control signal to the vehicle driving device 600 based on object information received from the object detection device 300.

The park-in system 750 may perform park-in of the vehicle 100 by providing a control signal to the vehicle driving device 600 according to a signal received from an external device via the communication device 400.

The park-in system 750 may include at least one of the UI device 270, the object detection device 300, the communication device 400, the driving manipulation device 500, the vehicle driving device 600, the navigation system 770, the sensing unit 120, or the controller 170 and may conceptually be a system that performs park-in of the vehicle 100.

The park-in system 750 may be referred to as a vehicle park-in control device.

The navigation system 770 may provide navigation information. The navigation information may include at least one of map information, set destination information, route information based on setting of a destination, information about various objects on a route, lane information, or information about a current location of a vehicle.

The navigation system 770 may include a memory and a processor. The memory may store navigation information. The processor may control operation of the navigation system 770.

In some embodiments, the navigation system 770 may receive information from an external device via the communication device 400 and update pre-stored information with the received information.

In some embodiments, the navigation system 770 may be classified as a low ranking component of the UI device 200.

The sensing unit 120 may sense a vehicle state. The sensing unit 120 may include an inertial navigation unit (IMU) sensor, a collision sensor, a wheel sensor, a speed sensor, an inclination sensor, a weight detection sensor, a heading sensor, a position module, a vehicle drive/reverse sensor, a battery sensor, a fuel sensor, a tier sensor, a steering sensor for rotation of the steering wheel, an in-vehicle temperature sensor, an in-vehicle humidity sensor, an ultrasonic sensor, an illuminance sensor, an acceleration pedal position sensor, a brake pedal position sensor, and so on.

The inertial navigation unit (IMU) sensor may include one or more of an acceleration sensor, a gyro sensor, and a magnetic sensor.

The sensing unit 120 may acquire a sensing signal of vehicle position information, vehicle motion information, vehicle yaw information, vehicle roll information, vehicle pitch information, vehicle collision information, vehicle heading information, vehicle location information (GPS information), vehicle angle information, vehicle speed information, vehicle acceleration information, vehicle inclination information, vehicle drive/reverse information, battery information, fuel information, wheel information, vehicle lamp information, vehicle internal temperature information, vehicle internal humidity information, a steering wheel rotation angle, a vehicle external illuminance, a pressure applied to an accelerator pedal, a pressure applied to a brake pedal, and so on.

The sensing unit 120 may further include an accelerator pedal sensor, a pressure sensor, an engine speed sensor, an air flow sensor (AFS), an air temperature sensor (ATS), a water temperature sensor (WTS), a throttle position sensor (TPS), a top dead center (TDC) sensor, a crank angle sensor (CAS), and so on.

The sensing unit 120 may generate vehicle state information based on the sensing data. The vehicle state information may be generated based on data detected by various sensors included in the vehicle.

For example, the vehicle state information may include vehicle position information, vehicle speed information, vehicle inclination information, vehicle weight information, vehicle heading information, vehicle battery information, vehicle fuel information, vehicle wheel air pressure information, vehicle steering information, in-vehicle temperature information, in-vehicle humidity information, pedal position information, vehicle engine temperature information, and so on.

The interface unit 130 serves paths to various types of external devices connected to the vehicle 100. For example, the interface unit 130 may be provided with a port connectable to a mobile terminal, and may be connected to a mobile terminal through the port. In this case, the interface unit 130 may exchange data with the mobile terminal.

The interface unit 130 may serve as a path along which electric energy is supplied to a connected mobile terminal. When the mobile terminal is electrically connected to the interface unit 130, the interface unit 130 may supply electric energy received from the power supply 190 to the mobile terminal under control of the controller 170.

The memory 140 is electrically connected to the controller 170. The memory 140 may store default data for a unit, control data for controlling the operation of the unit, and input and output data. The memory 140 may be any of various storage devices in hardware, such as read only memory (ROM), random access memory (RAM), erasable and programmable ROM (EPROM), flash drive, and hard drive. The memory 140 may store various data for an overall operation of the vehicle 100, such as programs for processing or control in the controller 170.

In some embodiments, the memory 140 may be integrated with the controller 170, or configured as a low ranking component of the controller 170.

The controller 170 may control an overall operation of each unit in the vehicle 100. The controller 170 may be referred to as an electronic control unit (ECU).

The power supply 190 may supply power required for an operation of each component under control of the controller 170. In particular, the power supply 190 may receive power from a battery, etc. in the vehicle.

One or more processors and the controller 170, included in the vehicle 100, may be implemented using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, or an electrical unit for performing other functions.

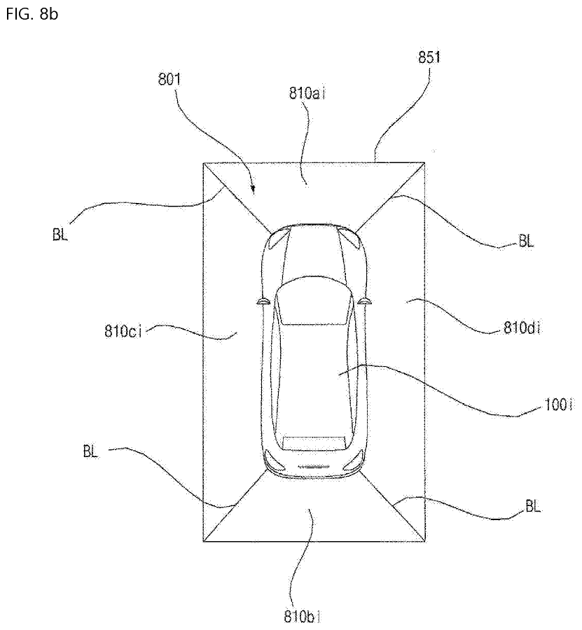

With reference to FIG. 8A and subsequent drawings, a vehicular around view image providing apparatus will be described below.

Referring to FIG. 8A, the vehicular around view image providing device 800 may include a plurality of cameras 810.

FIG. 8A illustrates an example in which the vehicular around view image providing device 800 includes four cameras 810a, 810b, 810c, and 810d. The vehicular around view image providing device 800 may include cameras, the number of which is less than 4 or is more than 4.

The plurality of cameras 810a, 810b, 810c, and 810d may be attached to at least one of a moving part and a fixed part of a vehicle body.

The moving part of the vehicle body refers to a moveable part among components of the vehicle body which forms an outer appearance and a frame of the vehicle. For example, the moving part of the vehicle body may include a side mirror, a door, a sunroof, a wiper, a bonnet (or a hood), a wheel, and a window.

The fixed part of the vehicle body refers to a non-moveable part among components of the vehicle body which forms an outer appearance and a frame of the vehicle. For example, the fixed part of the vehicle body may include a bumper, grill, a fender, a wheel house, a roof, or a wind shield.

A plurality of cameras 810 may include a front camera 810a, a rear camera 810b, a left lateral camera 810c, and a right lateral camera 810d.

The front camera 810a may acquire a front image of the vehicle 100.

The front camera 810a may be attached to a front bumper that is one of the fixed parts. The front camera 810a may be disposed inside the grill.

The rear camera 810b may acquire a rear image of the vehicle 100.

The rear camera 810b may be attached to a back door that is one of the moving parts. The back door may include a trunk and a tail gate.

The rear camera 810b may be attached to a rear bumper that is one of the fixed parts.

The left lateral camera 810c may acquire a left lateral image of the vehicle 100.

The left lateral camera 810c may be attached to a left side mirror that is one of the moving parts. Here, the left side mirror may include a mirror, various electrical components, a case that surrounds the mirror and the electrical components, and the like. The left side mirror may be referred to as a left side mirror module.

The left lateral camera 810c may be attached to a left front door that is one of the moving parts. The left front door may conceptually include a left side mirror.

The right lateral camera 810d may acquire a right lateral image of the vehicle 100.

The right lateral camera 810d may be attached to a right side mirror that is one of the moving parts. Here, the right side mirror may include a mirror, various electrical components, a case that surrounds the mirror and the electrical component, or the like. The right side mirror may be referred to as a right side mirror module.

The right lateral camera 810d may be attached to a right front door that is one of the moving parts. The right front door may conceptually include a right side mirror.

A first camera may refer to any one of the front camera 810a, the rear camera 810b, the left lateral camera 810c, and the right lateral camera 810d. A second camera may refer to a camera that is relatively adjacent to the first camera. For example, when the first camera is the front camera 810a, the second camera may be the left lateral camera 810c or the right lateral camera 810d. For example, when the first camera is the rear camera 810b, the second camera may be the left lateral camera 810c or the right lateral camera 810d. For example, when the first camera is the left lateral camera 810c, the second camera may be the front camera 810a or the rear camera 810b. For example, when the first camera is the right lateral camera 810d, the second camera may be the front camera 810a or the rear camera 810b.

FIG. 8B is a diagram showing an around view image generated by a vehicular around view image providing apparatus according to an embodiment of the present invention.

Referring to FIG. 8B, the vehicular around view image providing device 800 may generate an around view image 801.

A processor 870 of the vehicular around view image providing device 800 may match a plurality of images acquired by the plurality of cameras 810 to generate the around view image 801.

For example, the processor 870 of the vehicular around view image providing device 800 may match a front image acquired by the front camera 810a, a rear image acquired by the rear camera 810b, a left image acquired by the left lateral camera 810c, and a right image acquired by the right lateral camera 810d to generate the around view image 801.

The around view image 801 may include at least one of a top view image, a side view image, a front view image, or a back view image.

The around view image 801 may be embodied as a 2D or 3D image.

The around view image 801 may include a borderline BL. The borderline BL may be a line for defining regions that respectively correspond to a plurality of images acquired by the plurality of cameras 810 from the around view image 801.

For example, the around view image 801 may include a first region 810ai, a second region 810bi, a third region 810ci, and a fourth region 810di.

The first region 811i may be a region corresponding to a front image. The second region 812i may be a region corresponding to a rear image. The third region 813i may be a region corresponding to a left image. The fourth region 814i may be a region corresponding to a right image.

The around view image 801 may include a vehicle image 100i corresponding to the vehicle 100.

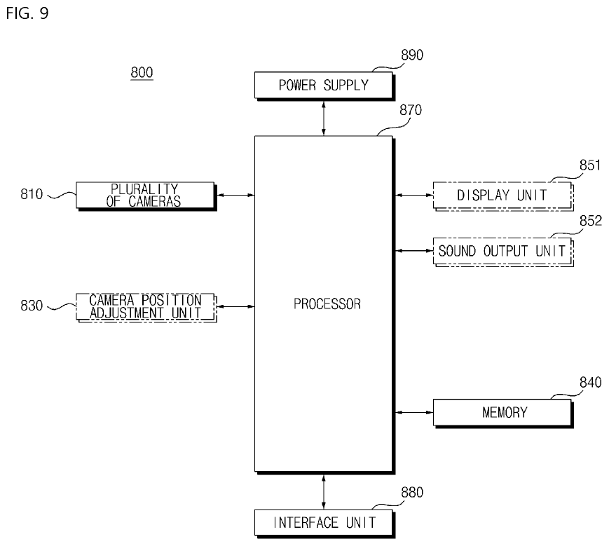

FIG. 9 is a block diagram for explanation of a vehicular around view image providing apparatus according to an embodiment of the present invention.

Referring to FIG. 9, the vehicular around view image providing device 800 may include the plurality of cameras 810, a memory 840, the processor 870, and a power supply 890.

In some embodiments, the vehicular around view image providing device 800 may separately include a camera position adjustment unit 830, a display unit 851, and a sound output unit 852 or may further include a combination thereof.

Each of the plurality of cameras 810 may be electrically connected to the processor 870. Each of the plurality of cameras 810 may be attached to a vehicle of the vehicle 100. The plurality of cameras 810 may be attached to at least one part of the moving part and the fixed part of the vehicle. Each of the plurality of cameras 810 may include a lens and an image sensor.

The plurality of cameras 810 may include a first camera and a second camera. For example, the first camera may be any one of the front camera 810a, the rear camera 810b, the left lateral camera 810c, and the right lat0eral camera 810d. The second camera may be a camera that is relatively adjacent to the first camera.

The first camera may be operated according to a signal received by the processor 870. The first camera may generate a first image. The first image may be a still image or a video image. The video image may include a plurality of frames. The first camera may provide the generated first image to the processor 870.

The second camera may be operated according to a signal received by the processor 870. The second camera may generate a second image. The second image may be a still image or a video image. The video image may include a plurality of frames. The second camera may provide the generated second image to the processor 870.

The camera position adjustment unit 830 may be electrically connected to the processor 870. The camera position adjustment unit 830 may control a position of each of the plurality of cameras 810 according to a signal received by the processor 870. The camera position adjustment unit 830 may include a plurality of driving units corresponding to the number of the plurality of cameras 810. The driving unit may include a driving force generating unit such as a motor, an actuator, or a solenoid. A position of each of the plurality of cameras 810 may be adjusted by an operation of the driving unit, and thus calibration may also be performed.

The camera position adjustment unit 830 may include a front driver corresponding to the front camera 810a, a rear driver corresponding to the rear camera 810b, a left side driver corresponding to the left lateral camera 810c, and a right side driver corresponding to the right lateral camera 810d. The camera position adjustment unit 830 may include a first driver corresponding to a first camera and a second driver corresponding to a second camera.

The memory 840 may be electrically connected to the processor 870. The memory 840 may store basic data of a predetermined unit, control data for control of an operation of a predetermined unit, and input and output data. The memory 840 may be various storage devices such as ROM, RAM, EPROM, flash drive, and hard drive in terms of hardware. The memory 840 may various data for an overall operation of the vehicular around view image providing device 800, such as a program for processing or controlling the processor 870. In some embodiments, the memory 840 may be integrated into the processor 870 or may be embodied as a low ranking component of the processor 870.

The display unit 851 may be electrically connected to the processor 870. The display unit 851 may display an around view image according to a signal received by the processor 870. The display unit 851 may be integrated into the display unit 251 of the UI device 200. The display unit 851 may be referred to as an audio video navigation (AVN) device, a center information display (CID), a head unit, or the like. The display unit 851 may be coupled to the communication device 400 to be embodied as a telematics device.

The sound output unit 852 may output an audio signal according to a signal received by the processor 870. The sound output unit 852 may be integrated into the audio output unit 252 of the UI device 200. The display unit 851 and the sound output unit 852 may be classified as a low-ranking component of an output unit of a vehicular around view image providing apparatus.

The processor 870 may be electrically connected to each unit of the vehicular around view image providing device 800. The processor 870 may provide an electrical signal to each unit of the vehicular around view image providing device 800 and may control an overall operation of each unit of the vehicular around view image providing device 800.

The processor 870 may be embodied using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, or an electrical unit for performing other functions.

The processor 870 may receive an image from each of the plurality of cameras 810. The processor 870 may receive a first image from a first camera. The first image may have a first view point. The processor 870 may receive a second image from a second camera. The second image may have a different second view point from the first view point.

The processor 870 may match images received from the plurality of cameras 810 to generate an around view image. The processor 870 may match a plurality of images including the first image received from the first camera and the second image received from the second camera to generate an around view image.

The processor 870 may detect a first object from the first image received from the first camera. The first object may include at least one of a lanes, a parking line, a traffic marker, a traffic cone, manhole, a crack, a curb, a traffic sign, or a foot print, which is positioned on a road around the vehicle 100. The processor 870 may detect a first feature of the first object detected from the first image. The first feature may include at least one of a shape, a planar area, a position, or an extension direction of an outline of a first object that is displayed in a state in which the first image is converted to an around view image.

The processor 870 may detect the first object from the second image received from the second camera. Here, the first object may be the same object as the first object detected from the first image. The processor 870 may detect a second feature of the first object detected from the second image. The second feature may include at least one of a shape, a planar area, a position, or an extension direction of an outline of the first object that is displayed in a state in which the second image is converted to the around view image. The second image may include the first object photographed at a different angle from the first image.

The processor 870 may compare the first feature of the first object detected based on the first image with the second feature of the first object detected based on the second image. For example, the processor 870 may compare the first feature of the first object in a region based on the first image of the around view image with the second feature of the first object in a region based on the second image of the around view image. For example, the processor 870 may compare an extension direction of a borderline of the first object based on the first image with an extension direction of a borderline of the first object based on the second image. For example, the processor 870 may compare a planar area of the first object based on the first image with a planar area of the first object based on the second image. For example, the processor 870 may compare a position of the first object based on the first image with a position of the first object based on the second image.

The processor 870 may determine whether calibration is performed based on the comparison result. Upon determining that calibration needs to be performed, the processor 870 may perform calibration on at least one of the first image, the second image, or the around view image.

The first image and the second image may be generated at different time points. When the vehicle 100 is moved, a time point when the first object enters a field of view (FOV) of the first camera may be different from a time point when the first object enters an FOV of the second camera. In this case, the first camera may generate the first image including the first object at a first time point and the second camera may generate the second image including the first object at a second time point after a predetermined time elapses from the first time point. The processor 870 may receive the first and second images at different time points. For example, the processor 870 may receive the first image at the first time point and may receive the second image at the second time point different from the first time point.

The processor 870 may determine whether discontinuity of the first object is detected from the around view image. When a pose of any one of the first and second cameras is changed by an external factor, the discontinuity of the first object may be detected from the around view image. This is because that the first object in the around view image based on the first image and the first object in the around view image based on the second image are not accurately matched. When the discontinuity of the first object is detected from the around view image, the processor 870 may perform calibration.

The processor 870 may compare the first feature with the second feature and may estimate a relative pose of at least one of the first camera or the second camera. The processor 870 may correct a transformation map (e.g., homography matrix) of an around view image based on the estimated pose of at least one of the first camera or the second camera to perform calibration. In some embodiments, the processor 870 may control the camera position adjustment unit 830 based on the estimated pose of at least one of the first camera or the second camera to adjust the pose of at least one of the first camera or the second camera.

The processor 870 may provide a signal corresponding to output of calibration performing state information. The processor 870 may provide the signal to the display unit 851 or the sound output unit 852. For example, the processor 870 may provide a signal for displaying information indicating that calibration is being performed, on the display unit 851. For example, the processor 870 may provide a signal for outputting voice information indicating that calibration is being performed, through the sound output unit 852. As such, the calibration performing state information may be output, and thus a user may recognize a normal state of the vehicle 100.

An interface unit 880 may be conductibly connected to the processor 870. The interface unit 880 may include at least one of a port, an element, and a device for exchanging signals with at least one device included in the vehicle 100. The interface unit 880 may exchange signals with at least one device included in the vehicle 100 in a wired or wireless manner.

The device included in the vehicle 100 may include the UI device 200, the object detection device 300, the communication device 400, the driving manipulation device 500, the vehicle driving device 600, the operation system 700, the navigation system 770, the sensing unit 120, the memory 140, the controller 170, and the power supply 190.

The interface unit 880 may receive a signal from at least one device included in the vehicle 100. The interface unit 880 may forward the received signal to the processor 880. The interface unit 880 may transmit the signal generated by the processor 870 to at least one device included in the vehicle 100.

The power supply 890 may be electrically connected to the processor 870. The power supply 890 may supply power required for an operation of each component of the vehicular around view image providing device 800 based on a control signal of the processor 870. For example, the power supply 890 may supply power required for an operation of at least one of the plurality of cameras 810, the camera position adjustment unit 830, the memory 840, the display unit 851, the sound output unit 852, the processor 870, or the interface unit 880. The power supply 890 may receive power from a power source (e.g., a battery) included in the vehicle 100.

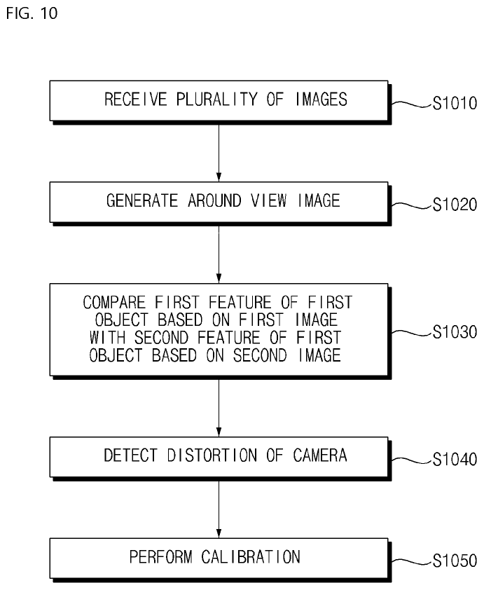

FIG. 10 is a diagram for explanation of an operation of a vehicular around view image providing apparatus according to an embodiment of the present invention. Referring to FIG. 10, the processor 870 may receive a plurality of images from the plurality of cameras 810 (S1010). For example, the processor 870 may receive a plurality of images from the front camera 810a, the rear camera 810b, the left lateral camera 810c, and the right lateral camera 810d.

The processor 870 may match a plurality of images to generate an around view image (S1020). For example, the processor 870 may match a front image received from the front camera 810a, a rear image received from the rear camera 810b, a left side image received from the left lateral camera 810c, and a right side image received from the right lateral camera 810d to generate an around view image. The around view image may be an image obtained by viewing the vehicle 100 in a predetermined direction. The around view image may be a top view image.

The processor 870 may compare the first feature of the first object based on the first image with the second feature of the first object based on the second image (S1030).

The processor 870 may estimate distortion of any one of the plurality of cameras 810 based on the comparison result of operation S1030 (S1040). For example, when the discontinuity of the first object is detected from the around view image, the processor 870 may detect distortion of any one of the plurality of cameras 810.

Upon detecting distortion of the camera, the processor 870 may perform calibration on at least one of the first image, the second image, or the around view image (S1050).

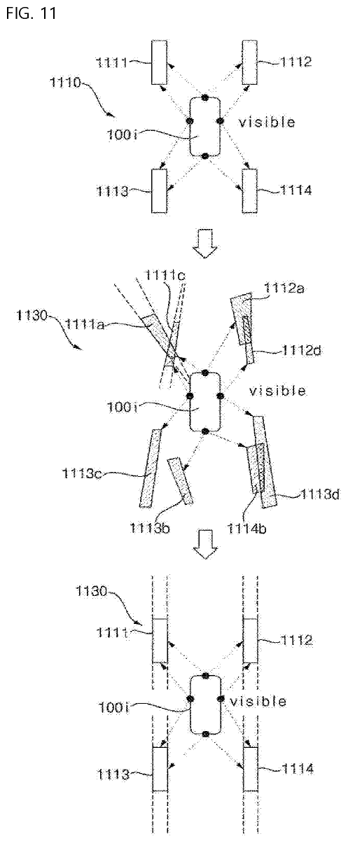

FIG. 11 is a diagram for explanation of a vehicular around view image providing apparatus according to an embodiment of the present invention.

Referring to FIG. 11, reference numeral 1110 is an example of an around view image generated by a vehicular around view image providing apparatus at the release from the factory. As exemplified in reference numeral 1110, the continuity of objects 1111, 1112, 1113, and 1114 may be ensured in an around view image formed by accurately matching images of a plurality of cameras. The objects 1111, 1112, 1113, and 1114 may include a first lane 1111, a second lane 1112, a third lane 1113, and a fourth lane 1114.

Reference numeral 1120 is an example of an around view image generated by a camera distorted by an external factor. Both the front camera 810a and the left lateral camera 810c may photograph the first lane 1111. When at least one of the front camera 810a or the left lateral camera 810c is distorted by an external factor, the discontinuity of the first lane 1111 may be generated. Both the front camera 810a and the right lateral camera 810d may photograph the second lane 1112. When at least one of the front camera 810a or the right lateral camera 810d is distorted by an external factor, the discontinuity of the second lane 1112 may be generated. Both the rear camera 810b and the left lateral camera 810c may photograph the third lane 1113. When at least one of the rear camera 810b or the left lateral camera 810c is distorted by an external factor, the discontinuity of the third lane 1113 may be generated. Both the rear camera 810b and the right lateral camera 810d may photograph the fourth lane 1114. When at least one of the rear camera 810b or the right lateral camera 810d is distorted by an external factor, the discontinuity of the fourth lane 1114 may be generated.

When the discontinuity with respect to an object is detected from the around view image, the processor 870 may perform calibration.

Reference numeral 1130 is an example of an around view image generated after calibration is performed. After calibration is performed, the continuity of the objects 1111, 1112, 1113, and 1114 may be ensured from the around view image formed by accurately matching images of a plurality of cameras, as exemplified in reference numeral 1130.

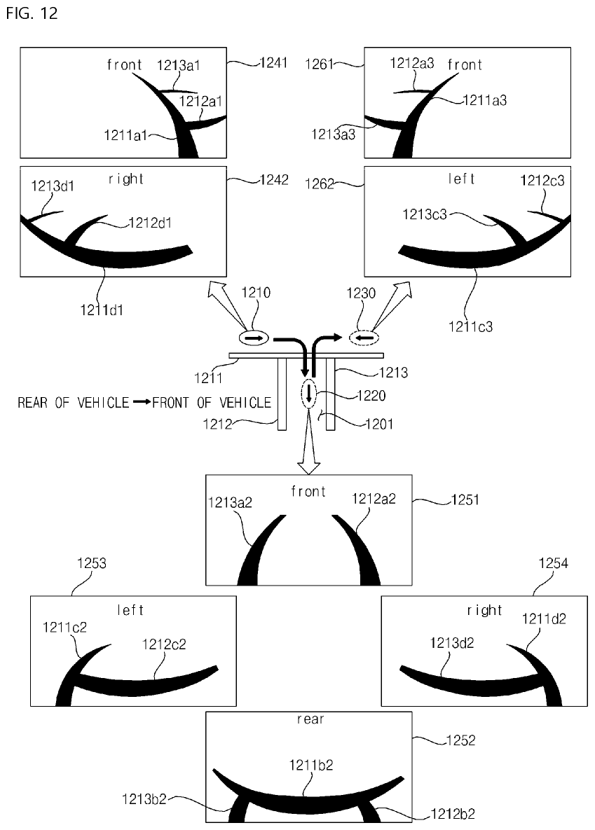

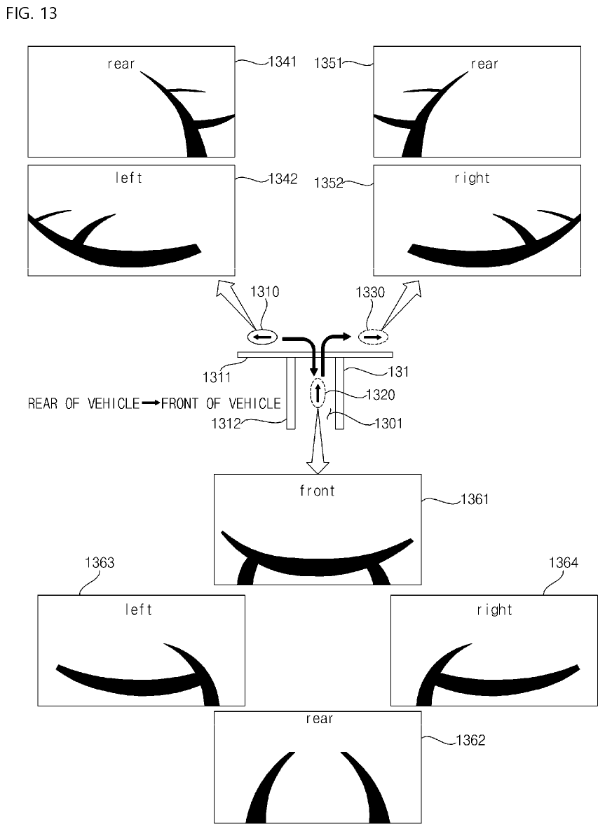

FIGS. 12 and 13 are diagrams showing an example of a plurality of images generated from a plurality of images according to an embodiment of the present invention.

FIG. 12 illustrates an example of images acquired by the plurality of cameras 810 in a situation in which the vehicle 100 enters the parking space 1201 in a forward direction (1220) from a left side 1210 of a parking space 1201 and then moves backward to a right side 1230 of the parking space 1201. The parking space 1201 may be defined as a space that is surrounded by a first parking line 1211, a second parking line 1212, and a third parking line 1213.

In a situation in which the vehicle 100 moves around the parking space 1201, the plurality of cameras 810 may generate a plurality of images, respectively. The processor 870 may perform calibration based on the plurality of images that are acquired by the plurality of cameras 810, respectively.

In a situation in which the vehicle 100 is positioned at one point 1210 of a left side of the outside of the parking space 1201, the plurality of cameras 810 may photograph a parking line. The front camera 810a may generate a front image 1241 including a first parking line image 1211a1, a second parking line image 1212a1, and a third parking line image 1213a1. The right lateral camera 810d may generate a right side image 1242 including a first parking line image 1211d1, a second parking line image 1212d1, and a third parking line image 1213d1. The processor 870 may perform calibration based on the parking line image included in the front image 1241 and the parking line image included in the right side image 1242.

In a situation in which the vehicle 100 is positioned at one point 1220 inside the parking space 1201, the plurality of cameras 810 may photograph a parking line. The front camera 810a may generate a front image 1251 including a second parking line image 1212a2 and a third parking line image 1213a2. The rear camera 810b may generate a rear image 1252 including a first parking line image 1211b2, a second parking line image 1212b2, and a third parking line image 1213b2. The left lateral camera 810c may generate a left side image 1253 including a first parking line image 1211c2 and a second parking line image 1212c2. The right lateral camera 810d may generate a right side image 1254 including a first parking line image 1211d2 and a third parking line image 1213d2. The processor 870 may perform calibration based on a parking line image included in the front image 1251 and a parking line image included in the left side image 1253. The processor 870 may perform calibration based on a parking line image included in the front image 1251 and a parking line image included in the right side image 1254. The processor 870 may perform calibration based on a parking line image included in the rear image 1252 and a parking line image included in the left side image 1253. The processor 870 may perform calibration based on a parking line image included in the rear image 1252 and a parking line image included in the right side image 1254.

In a situation in which the vehicle 100 is positioned at one point 1230 of a right side of the outside of the parking space 1201, the plurality of cameras 810 may photograph a parking line. The front camera 810a may generate a front image 1261 including a first parking line image 1211a3, a second parking line image 1212a3, and a third parking line image 1213a3. The left lateral camera 810c may generate a left side image 1262 including a first parking line image 1211c3, a second parking line image 1212c3, and a third parking line image 1213c3. The processor 870 may perform calibration based on a parking line image included in the front image 1261 and a parking line image included in the left side image 1262.

FIG. 13 is an example of images acquired by the plurality of cameras 810 in a situation in which the vehicle 100 enters the parking space 1301 in a backward direction (1320) from a left side 1310 of a parking space 1301 and then moves forward to a right side 1330 of the parking space 1301. The parking space 1301 may be defined as a space that is surrounded by a first parking line 1311, a second parking line 1312, and a third parking line 1313.

The description of FIG. 12 is applied to the situation of FIG. 13 except that directions of an object included in an acquired image are different from each other depending on whether a vehicle enters the parking space 1301 in a backward direction or enters the parking space 1201 in a forward direction. A detailed description thereof is omitted.

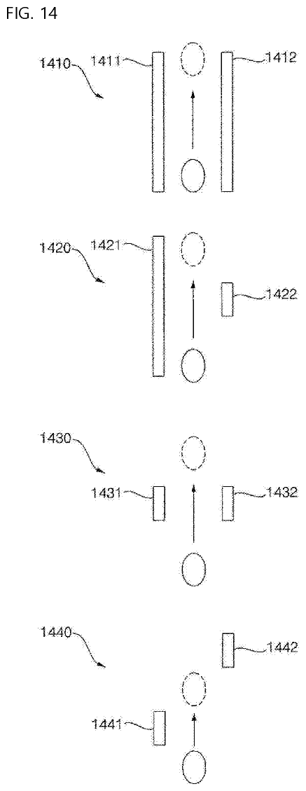

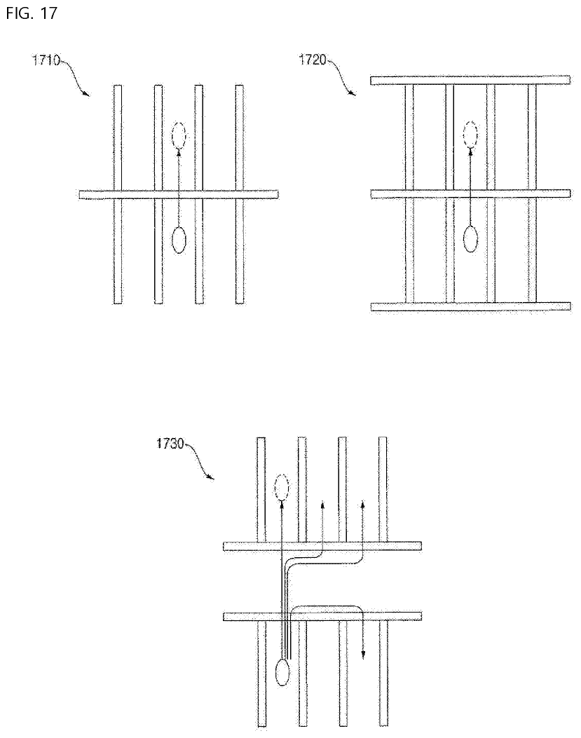

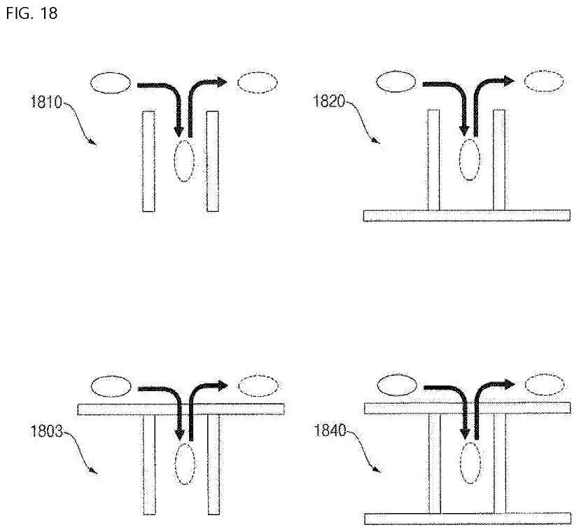

FIGS. 14 to 23 are diagrams for explanation of various operation scenarios of a vehicular around view image providing apparatus according to an embodiment of the present invention.

An oval indicates a vehicle, and an arrow between ovals indicates a direction of the vehicle. A beginning part of the arrow indicates a rear part of the vehicle, and a portion of the arrow, which indicates a direction, indicates a front part of the vehicle. A solid line of the oval indicates a forward direction of the vehicle, and a dotted line of the oval indicates a backward direction.

In FIGS. 14 to 23, a vehicle is assumed to perform autonomous driving or autonomous parking.

FIG. 14 is a diagram for explanation of an operation scenario for performing calibration when a vehicle travels on a road according to an embodiment of the present invention.

Referring to FIG. 14, the processor 870 may perform calibration based on an image generated by the plurality of cameras 810 when the vehicle 100 travels on a road.

The processor 870 may receive a first image from a first camera and may receive a second image from a second camera. The processor 870 may compare a first feature of a first object detected based on the first image with a second feature of the first object detected based on the second image and may perform calibration.

The first object may include at least some of lanes 1411, 1412, 1421, 1422, 1431, 1432, 1441, and 1442. The first camera may generate the first image while the vehicle 100 travels. The second camera may generate the second image while the vehicle 100 travels.

The first camera and the second camera may generate the first image and the second image, respectively, with a time difference. The first camera may generate the first image including at least some of the first lane at a first time point. The second camera may generate the second image including at least some of the first lane at a second time point after a predetermined time elapses from the first time point.

A lane used in calibration may include at least one of a solid line, a dotted line, a center line, a crosswalk, a stop line, or a borderline of a lane and a sidewalk.

As exemplified in reference numeral 1410, in a situation in which the vehicle 100 travels in a lane defined by solid lines 1411 and 1412, the first camera and the second camera may respectively generate the first image and the second image including at least some of the solid lines 1411 and 1412.

As exemplified in reference numeral 1420, in a situation in which the vehicle 100 travels in a lane defined by a solid line 1421 and a dotted line 1422, the first camera and the second camera may respectively generate the first image and the second image including at least some of the solid line 1421 and the dotted line 1422.

As exemplified in reference numeral 1430, in a situation in which the vehicle 100 travels in a lane defined by dotted lines 1431 and 1432, the first camera and the second camera may respectively generate the first image and the second image including at least some of the dotted lines 1431 and 1432.

As exemplified in reference numeral 1430, in a situation in which the vehicle 100 travels in a lane defined by dotted lines 1441 and 1442, the first camera and the second camera may respectively generate the first image and the second image including a first dotted line 1441 at a first time point. A third camera and a fourth camera may respectively generate a third image and a fourth image including a second dotted line 1442 at a second time point after a predetermined time elapses from the first time point. In this case, the processor 870 may perform calibration on an image based on the first camera and an image based on the second camera, based on the first image and the second image that are generated at the first time point. The processor 870 may perform calibration on an image based on the third camera and an image based on the fourth camera, based on the third image and the fourth image, which are generated at the second time point.

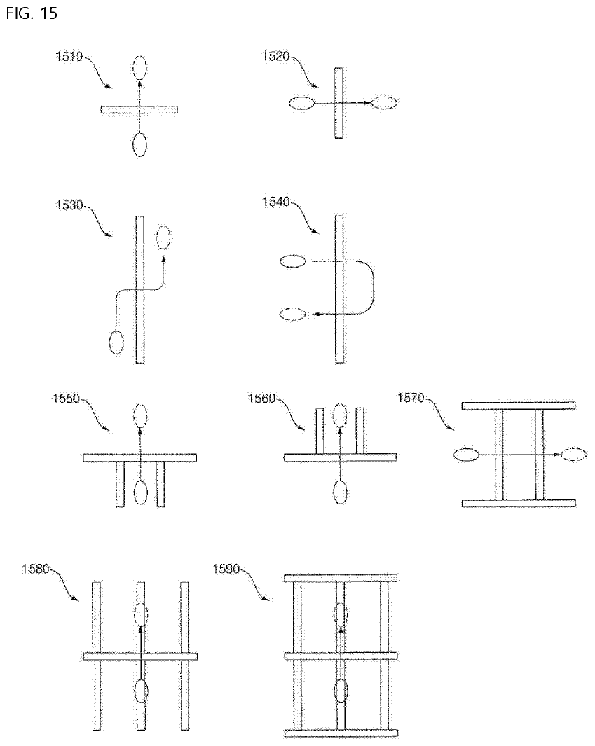

FIGS. 15 to 21 are diagrams for explanation of operation scenarios in which calibration is performed while parking according to an embodiment of the present invention.

Referring to FIGS. 15 to 21, the processor 870 may perform calibration based on an image generated by the plurality of cameras 810 while the vehicle 100 parks.

The processor 870 may receive the first image from the first camera and may receive the second image from the second camera. The processor 870 may compare a first feature of a first object detected based on the first image with a second feature of the first object detected based on the second image and may perform calibration.

The first object may include at least some of a parking line.

In some embodiments, the processor 870 may provide a signal for moving of the vehicle 100 in order to acquire an image based on which calibration is performed. For example, the processor 870 may provide a signal for at least one of forward movement, backward movement, or turn of the vehicle 100 in order to acquire the first image and the second image. The processor 870 may provide a signal to at least one of the controller 170 or the vehicle driving device 600 (e.g., a power source driver 611, a steering driver 621, and a brake driver 622).

The processor 870 may provide a signal for at least one of forward movement, backward movement, or turn of the vehicle in such a way that at least one wheel included in the vehicle 100 approaches the first parking line. In a situation in which the vehicle 100 approaches the first parking line, the plurality of cameras 810 may generate an image including the first parking line image, and the processor 870 may perform calibration.

The processor 870 may provide a signal for at least one of forward movement, backward movement, or turn of the vehicle 100 in such a way that at least one wheel included in the vehicle 100 approaches the first parking line.

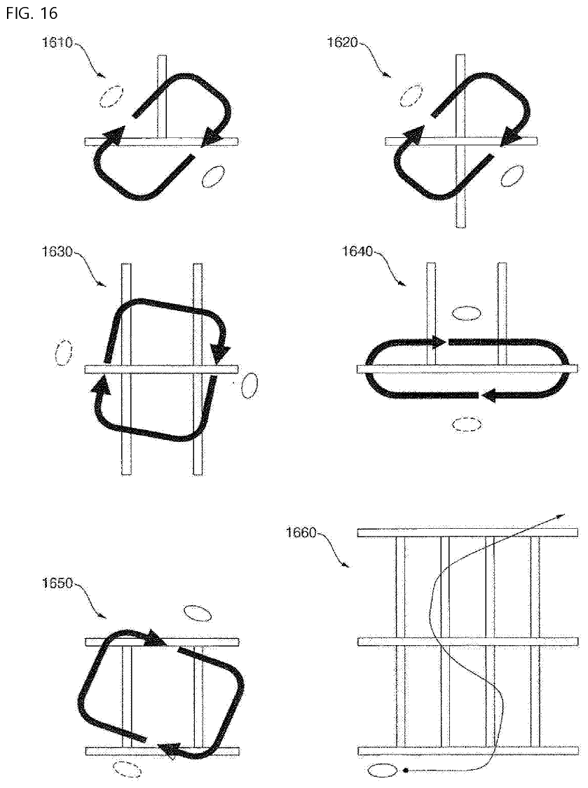

As exemplified in FIGS. 15 and 16, the processor 870 may provide a signal for at least one of forward movement, backward movement, or turn of the vehicle 100 in various patterns.

As exemplified in reference numeral 1510, the processor 870 may provide a signal in such a way that the vehicle 100 moves to cross a parking line that extends in a horizontal direction. The processor 870 may provide a signal for at least one of forward movement, backward movement, or turn of the vehicle 100 in such a way that at least one wheel included in the vehicle 100 crosses a parking line extending in a horizontal direction.

As exemplified in reference numeral 1520, the processor 870 may provide a signal in such a way that the vehicle 100 moves to cross a parking line that extends in a vertical direction. The processor 870 may provide a signal for at least one of forward movement, backward movement, or turn of the vehicle 100 in such a way that at least one wheel included in the vehicle 100 crosses a parking line that extends in a vertical direction.

As exemplified in reference numeral 1530, the processor 870 may provide a signal in such a way that the vehicle 100 travels along a parking line that extends in a vertical direction, crosses the parking line, and then travels again along the parking line. The processor 870 may provide a signal in such a way that the vehicle 100 has a traveling pattern of “S” shape based on the parking line.

As exemplified in reference numeral 1540, the processor 870 may provide a signal in such a way that the vehicle 100 crosses and passes a parking line that extends in a vertical direction and then crosses and passes gain the parking line. The processor 870 may provide a signal in such a way that the vehicle 100 has a traveling pattern of “C” shape based on the parking line.

As exemplified in reference numeral 1550, the processor 870 may provide a signal in such a way that the vehicle 100 exits a parking space while crossing a parking line that extends in a horizontal direction in a state in which the vehicle 100 is positioned in the parking space.

As exemplified in reference numeral 1560, the processor 870 may provide a signal in such a way that the vehicle 100 enters a parking space while crossing a parking line that extends in a horizontal direction in a state in which the vehicle 100 is positioned outside the parking space.

As exemplified in reference numeral 1570, the processor 870 may provide a signal in such a way that the vehicle 100 crosses a parking line that extends in a vertical line and passes a parking space.

As exemplified in reference numerals 1580 and 1590, the processor 870 may provide a signal in such a way that the vehicle 100 moves while a parking line that extends in a vertical direction is positioned between left and right wheels.

As exemplified in reference numeral 1610 to 1650, the processor 870 may provide a signal in such a way that the vehicle 100 turns based on an intersection of two or more parking lines. For example, the processor 870 may provide a signal to have a traveling pattern that forms a loop based on an intersection. In this case, at least one intersection may be present in a traveling loop. For example, the processor 870 may provide a signal to have a traveling pattern with a spiral shape based on an intersection.

As exemplified in reference numeral 1660, the processor 870 may provide a signal in such a way that the vehicle 100 travels to have an arbitrary path on at least one parking line.

The processor 870 may provide a signal for at least one of forward movement, backward movement, or turn of the vehicle 100 in such a way that the vehicle 100 moves to a second parking space from a first parking space.

As exemplified in reference numerals 1710 to 1720, the processor 870 may provide a signal in such a way that the vehicle 100 moves to the second parking space adjacent to the first parking space from the first parking space.

As exemplified in reference numeral 1730, the processor 870 may provide a signal in such a way that the vehicle 100 moves to the second parking space spaced apart from the first parking space, from the first parking space.

The processor 870 may provide a signal for at least one of forward movement, backward movement, or turn of the vehicle in such a way that the vehicle 100 enters the first parking space in a first direction and then exits from the first parking space.

As exemplified in reference numeral 1810 to 1840, the processor 870 may provide a signal in such a way that the vehicle 100 enters the first parking space in a forward direction or a backward direction and then exits from the first parking space. The processor 870 may provide a signal in such a way that a traveling pattern of the vehicle 100 forms a T pattern. The parking space may be formed by one pair of extension lines in a vertical direction. Alternatively, the parking space may be formed by one pair of extension lines in a vertical line and at least one extension line in a horizontal line.

The processor 870 may provide a signal for at least one of forward movement, backward movement, or turn of the vehicle 100 in such a way that the vehicle 100 exits from the first parking space and then parks in the first parking space.

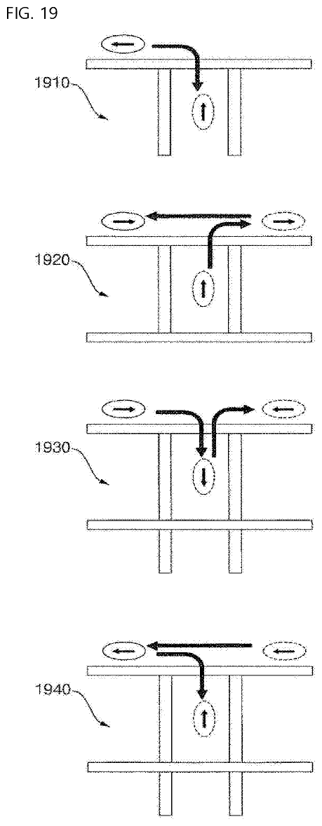

Referring to FIG. 19, as exemplified in reference numeral 1910, the vehicle 100 may enter a parking space. The processor 870 may determine whether calibration is required. When calibration is not determined to be required, parking is completed.

Upon determining that calibration is required, the processor 870 may provide a signal for outputting information indicating a calibration performing state. For example, the processor 870 may provide a signal for outputting a message indicating that data for performing calibration is being collected. In addition, the processor 870 may provide a signal for outputting a data collection rate.

Upon determining that calibration is required, the processor 870 may provide a signal in such a way that the vehicle 100 moves, as exemplified in reference numerals 1920 to 1940. In detail, the processor 870 may provide a signal in such a way that the vehicle 100 exits a parking space, changes a direction, and then enters the parking space again. For example, the processor 870 may provide a signal in such a way that the vehicle 100 exits the parking space and then enters again the parking space in a backward direction in a state in which the vehicle 100 enters the parking space in a forward direction. For example, the vehicle 100 may provide a signal in such way that the vehicle 100 exits the parking space and then enters again the parking in a forward direction in a state in which the vehicle 100 enters the parking space in a backward direction. Through this procedure, a plurality of images for performing calibration may be acquired.

In some embodiments, the processor 870 may provide a signal in such way that the vehicle 100 exits the parking space repeatedly two times or greater, changes a direction of entering the parking space, and enters again the parking space. Through this control, a relatively large amount of data may be acquired to perform more accurate calibration.

The processor 870 may perform calibration based on a plurality of images that are acquired while the vehicle 100 moves. The processor 870 may provide a signal for outputting a message indicating that calibration is being performed. After calibration is completed, the processor 870 may provide a signal for outputting a success message or a failure message of calibration.

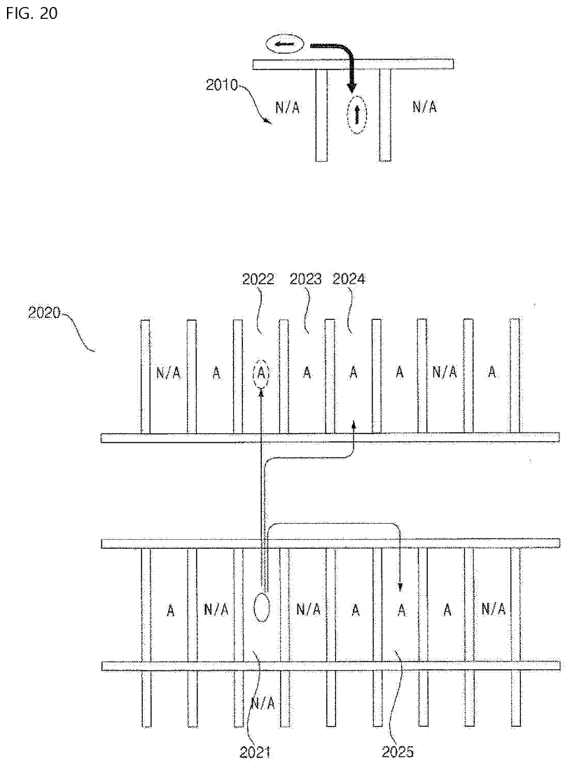

Referring to FIG. 20, as exemplified in reference numeral 2010, the vehicle 100 may enter a parking space. The processor 870 may determine whether calibration is required. When calibration is not determined to be required, parking is completed.

Upon determining that calibration is required, the processor 870 may provide a signal for outputting information on a calibration performing state. For example, the processor 870 may provide a signal for outputting a message indicating that data for performing calibration is being collected. In addition, the processor 870 may provide a signal for outputting a data collection rate.

Upon determining that calibration is required, the processor 870 may provide a signal in such a way that the vehicle 100 moves, as exemplified in reference numeral 2020. In detail, the processor 870 may provide a signal in such a way that the vehicle 100 exits a parking space and then finds and enters parking spaces 2022, 2023, 2024, and 2025, sides of which do not have other vehicles therein.

The processor 870 may perform calibration based on a plurality of images acquired while the vehicle 100 moves. The processor 870 may provide a signal for outputting a message indicating that calibration is being performed. After calibration is completed, the processor 870 may provide a signal for outputting a success message or a failure message of calibration.

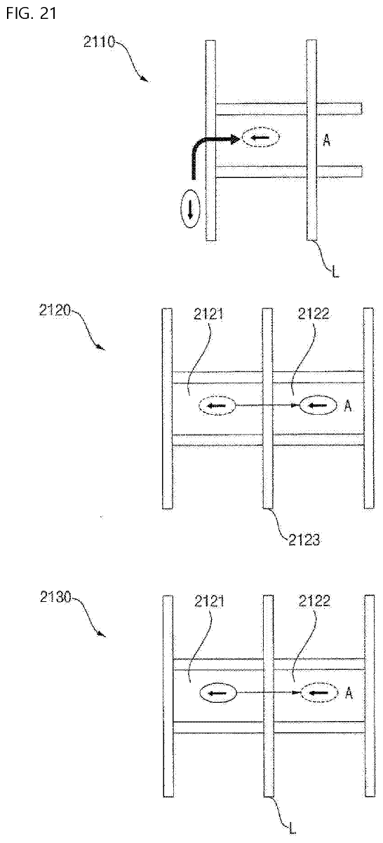

Referring to FIG. 21, as exemplified in reference numeral 2110, the vehicle 100 may enter a parking space. The processor 870 may determine whether calibration is required. When calibration is not determined to be required, parking may be completed.

Upon determining that calibration is required, the processor 870 may provide a signal for outputting information on a calibration performing state. For example, the processor 870 may provide a signal for outputting a message indicating that data for performing calibration is being collected. In addition, the processor 870 may provide a signal for outputting a data collection rate.

Upon determining that calibration is required, the processor 870 may provide a signal in such a way that the vehicle 100 moves, as exemplified in reference numerals 2120 to 2130. In detail, the processor 870 may provide a signal in such a way that the vehicle 100 moves backward to a second parking space 2122 adjacent to the first parking space 2121 from a first parking space 2121 in which the vehicle 100 is positioned. In this case, the processor 870 may provide a signal in such a way that the vehicle 100 moves in a backward direction in order to allow a parking line 2123 for differentiating the first parking space 2121 and a second parking space 2122 from each other to enter an FOV of the front camera 810a. Then, the processor 870 may provide a signal in such a way that the vehicle 100 moves in a forward direction to the first parking space 2121 from the second parking space 2122. In this case, the processor 870 may provide a signal in such a way that the vehicle 100 moves in a forward direction in order to allow the parking line 2123 to enter an FOV of the rear camera 810b.

The processor 870 may perform calibration based on a plurality of images acquired while the vehicle 100 moves. The processor 870 may provide a signal for outputting a message indicating that calibration is being performed. After calibration is completed, the processor 870 may provide a signal for outputting a success message or a failure message of calibration.

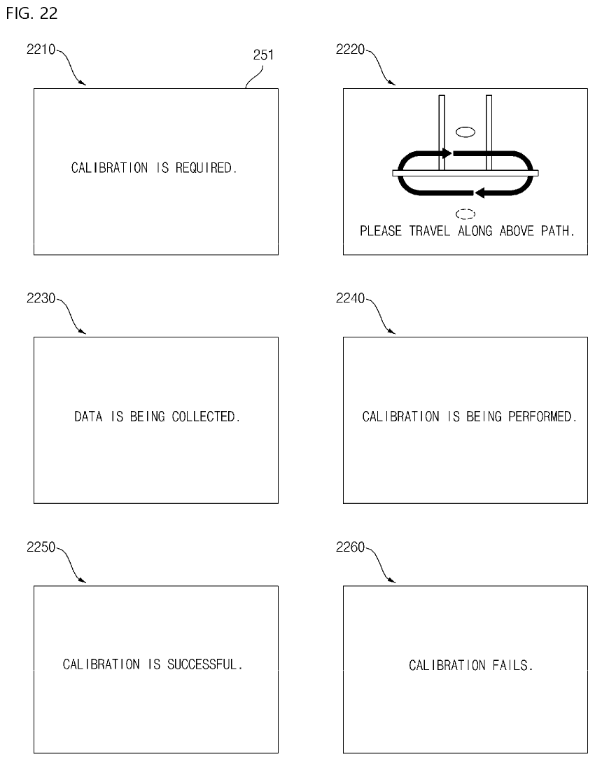

FIG. 22 is a diagram for explanation of an operation scenario of guiding user traveling and performing calibration according to an embodiment of the present invention.

Referring to FIG. 22, the processor 870 may provide a signal for outputting driving guidance in order to acquire a plurality of images.

The processor 870 may determine whether calibration is required. As exemplified in reference numeral 2210, upon determining that calibration is required, the processor 870 may provide a signal for outputting a message indicating necessity of calibration.

As exemplified in reference numeral 2220, the processor 870 may provide a signal for displaying an environment in which calibration is possible. For example, the processor 870 may provide a signal for displaying a space in which at least one parking line is positioned as the environment in which calibration is possible. The processor 870 may provide a signal for displaying a traveling path in the environment in which calibration is possible.

In a state in which a user travels along a provided traveling path, the processor 870 may acquire a plurality of images that are respectively generated by the plurality of cameras 810. In this case, as exemplified in reference numeral 2230, the processor 870 may provide a signal for outputting a message indicating that data is being collected.

The processor 870 may perform calibration based on the acquired plurality of images. In this case, as exemplified in reference numeral 2240, the processor 870 may provide a signal for outputting a message indicating that calibration is being performed.

After calibration is completed, the processor 870 may provide a signal for outputting a success message 2250 or a failure message 2260 of calibration. When calibration fails, the processor 870 may provide a signal for outputting a button for receiving input of reattempt of calibration.

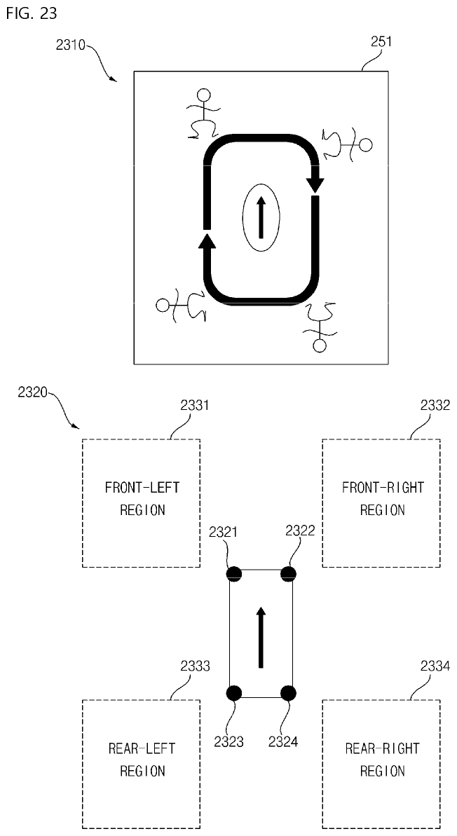

FIG. 23 is a diagram for explanation of an operation scenario in which calibration is performed when a fixed object is not present around according to an embodiment of the present invention.

Referring to FIG. 23, a first object may include a foot print. The processor 870 may provide a signal for outputting guidance of a user position outside the vehicle 100 in order to acquire a plurality of images of the foot print. The processor 870 may provide a signal for outputting guidance of a user position outside the vehicle 100 in order to acquire the first image and the second image.

The processor 870 may provide a signal for at least one turn signal lamp operation in order to acquire a plurality of images of foot print. The processor 870 may provide a signal for a first turn signal lamp operation in order to acquire the first image and the second image. For example, the processor 870 may control the first camera to generate the first image and may control the second camera to generate the second image in a state in which a signal for blinking a first turn signal lamp is provided.

As exemplified in reference numeral 2310, upon determining that calibration is required, the processor 870 may provide a signal for outputting guidance of a user position.

The processor 870 may provide a signal for an operation of at least one turn signal lamps 2321, 2322, 2323, and 2324. The processor 870 may provide a signal to at least one of the controller 170 or the lamp driving unit 650.

For example, the processor 870 may provide a signal for blinking a front left turn signal lamp 2321. The user may be positioned in a front left region 2331. The front camera 810a may generate a front image including an image of a user foot that contacts the ground. The left lateral camera 810c may generate a left side image including the image of the user foot that contacts the ground. The processor 870 may perform calibration based on the front image and the left side image. The processor 870 may provide a signal for blink termination when calibration is completed.

For example, the processor 870 may provide a signal for blinking a front right turn signal lamp 2322. The user may be positioned in a front right region 2332. The front camera 810a may generate a front image including an image of a user foot that contacts the ground. The right lateral camera 810d may generate a right side image including an image of the user foot that contacts the ground. The processor 870 may perform calibration based on the front image and the right side image. The processor 870 may provide a signal for blink termination when calibration is completed.

For example, the processor 870 may provide a signal for blinking a rear left turn signal lamp 2323. The user may be positioned in a rear left region 2333. The rear camera 810b may generate a rear image including an image of a user foot that contacts the ground. The left lateral camera 810c may generate a left side image including an image of the user food that contacts the ground. The processor 870 may perform calibration based on the rear image and the left side image. The processor 870 may provide a signal for blink termination when calibration is completed.

For example, the processor 870 may provide a signal for blinking a rear right turn signal lamp 2324. The user may be positioned in a rear right region 2334. The rear camera 810b may generate a rear image including an image of a user foot that contacts the ground. The right lateral camera 810d may generate a right side image including an image of the user foot that contacts the ground. The processor 870 may perform calibration based on the rear image and the right side image. The processor 870 may provide a signal for blink termination when calibration is completed.

The invention can also be embodied as computer readable code on a computer readable recording medium. The computer readable recording medium is any data storage device that can store data which can be thereafter read by a computer system. Examples of the computer readable recording medium include hard disk drive (HDD), solid state disk (SSD), silicon disk drive (SDD), ROM, RAM, CD-ROM, magnetic tapes, floppy disks, optical data storage devices, etc. and include a carrier wave (for example, a transmission over the Internet). In addition, the computer may include a processor or a controller. Accordingly, it will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

### DESCRIPTION OF REFERENCE NUMERAL

100: vehicle
800: vehicular around view image providing apparatus.

What is claimed:

1. A vehicular around view image providing apparatus comprising:
a first camera configured to generate a first image;
a second camera configured to generate a second image; and
a processor that is configured to:
generate an around view image by matching a plurality of images including the first image and the second image, compare a first feature of a first object detected based on the first image with a second feature of the first object detected based on the second image, and perform calibration on at least one of the first image, the second image, or the around view image.

2. The vehicular around view image providing apparatus of claim 1, wherein the processor is configured to receive the first image at a first time point and receive the second image at a second time point different from the first time point.

3. The vehicular around view image providing apparatus of claim 1, wherein the processor is configured to perform calibration when discontinuity of the first object is detected from the around view image.

4. The vehicular around view image providing apparatus of claim 1, wherein the processor is configured to compare the first feature with the second feature and correct a transformation map of the around view image based on a pose of at least one of the first camera and the second camera.

5. The vehicular around view image providing apparatus of claim 1, wherein the first object includes at least some of a lane, the first camera generates the first image while a vehicle travels, and the second camera generates the second image while the vehicle travels.

6. The vehicular around view image providing apparatus of claim 5, wherein the first camera generates the first image including at least some of a first lane at a first time point, and the second camera generates the second image including at least some of the first lane at a second time point.

7. The vehicular around view image providing apparatus of claim 1, wherein the first object includes at least some of a parking line, and the processor is configured to provide a signal for at least one of forward movement, backward movement, or turn of a vehicle, for acquiring the first image and the second image.

8. The vehicular around view image providing apparatus of claim 7, wherein the processor is configured to provide a signal for at least one of forward movement, backward movement, or turn of the vehicle so that at least one wheel included in the vehicle approaches a first parking line.

9. The vehicular around view image providing apparatus of claim 8, wherein the processor is configured to provide a signal for at least one of forward movement, backward movement, or turn of the vehicle so that at least one wheel included in the vehicle passes the first parking line.

10. The vehicular around view image providing apparatus of claim 8, wherein the processor is configured to provide a signal for at least one of forward movement, backward movement, or turn of the vehicle so that the vehicle moves to a second parking space from a first parking space.

11. The vehicular around view image providing apparatus of claim 8, wherein the processor is configured to provide a signal for at least one of forward movement, backward movement, or turn of the vehicle so that the vehicle enters the first parking space in a first direction and then exits from the first parking space.

12. The vehicular around view image providing apparatus of claim 8, wherein the processor is configured to provide a signal for at least one of forward movement, backward movement, or turn of the vehicle so that the vehicle exits the first parking space and then parks in the first parking space in a state in which the vehicle enters the first parking space.

13. The vehicular around view image providing apparatus of claim 7, wherein the processor is configured to provide a signal corresponding to output of calibration performing state information.

14. The vehicular around view image providing apparatus of claim 1, wherein the processor is configured to provide a signal for outputting guidance of a user position outside the vehicle, for acquiring the first image and the second image.

15. The vehicular around view image providing apparatus of claim 14, wherein the processor is configured to provide a signal for an operation of a first turn signal lamp, for acquiring the first image and the second image, and control the first camera to generate the first image and control the second camera to generate the second image in a state in which a signal for blinking the first turn signal lamp is provided.
